(19) United States
(12) Patent Application Publication
(10) Pub. No.: US 2015/0220265 A1
(43) Pub. Date: Aug. 6, 2015

(54) INFORMATION PROCESSING DEVICE, INFORMATION PROCESSING METHOD, AND PROGRAM

(71) Applicant: SONY CORPORATION, TOKYO (JP)

(72) Inventor: KEI TAKAHASHI, TOKYO (JP)

(21) Appl. No.: 14/606,770

(22) Filed: Jan. 27, 2015

(30) Foreign Application Priority Data
Feb. 6, 2014 (JP) 2014-021479

(51) Int. Cl. G06F 3/0488; G06K 9/00

(52) U.S. Cl. CPC G06F 3/04883; G06K 9/00416

(57) ABSTRACT

Provided is an information processing device including an operation information acquisition unit configured to acquire operation information that is information regarding operation input by a user, and a display control unit configured to cause at least a candidate of a letter corresponding to a stroke operation, which is an operation determined based on the operation information and indicates a predetermined direction, to be displayed on a screen according to the stroke operation.

### CROSS REFERENCE TO RELATED APPLICATIONS

This application claims the benefit of Japanese Priority Patent Application JP 2014-021479 filed Feb. 6, 2014, the entire contents of which are incorporated herein by reference.

### BACKGROUND

The present disclosure relates to an information processing device, an information processing method, and a program.

Recently, information processing devices such as tablet personal computers (PCs) and the like have been equipped with a handwritten character recognition function of recognizing characters that are input by a user in handwriting based on movements of an operating body such as a stylus on, for example, a touch panel. Various technologies with respect to handwritten character recognition have been developed in order to boost accuracy in character recognition and user convenience during input. For example, JP 2003-271899A discloses a technology in which, while a user inputs a sequence of characters in handwriting, it is determined in parallel whether a stroke that is newly input belongs to characters of a sequence of characters that have already been input, or belongs to characters that will be newly input, and thereby a possibility of erroneous recognition of a character is lowered with a shortened waiting time for character recognition.

### SUMMARY

Here, when a character with many strokes is to be input in handwriting, for example, it is necessary for an operating body with which the plurality of strokes are input to be operated complicatedly, and thus there is a possibility of input of one character taking a longer period of time than input with a keyboard. Thus, a technology that further reduces burdens on users by enabling them to perform handwriting input with a simpler operation has been demanded.

In addition, in recent years, so-called wearable devices, for example, wristwatch-type information processing devices and the like that have been developed on the assumption that users wear and use them every day are becoming widespread. Wearable devices tend to have a miniaturized terminal in comparison to other types of information processing devices in view of portability, and thus screens are also demanded to be miniaturized. When characters are input to such a terminal having a smaller screen in handwriting, there is concern of user operability of the operating body decreasing and user convenience deteriorating.

Considering the above-described circumstances, further increases in user convenience in handwriting input of letters, numbers, or symbols have been demanded. Thus, the present disclosure proposes a novel and improved information processing device, information processing method, and program that can further boost user convenience.

According to an embodiment of the present disclosure, there is provided an information processing device including an operation information acquisition unit configured to acquire operation information that is information regarding operation input by a user, and a display control unit configured to cause at least a candidate of a letter corresponding to a stroke operation, which is an operation determined based on the operation information and indicates a predetermined direction, to be displayed on a screen according to the stroke operation.

According to another embodiment of the present disclosure, there is provided an information processing method including acquiring operation information that is information regarding operation input by a user, and causing at least a candidate of a letter corresponding to a stroke operation, which is an operation determined based on the operation information and indicates a predetermined direction, to be displayed on a screen according to the stroke operation.

According to another embodiment of the present disclosure, there is provided a program causing a processor of a computer to realize functions of acquiring operation information that is information regarding operation input by a user, and causing at least a candidate of a letter corresponding to a stroke operation, which is an operation determined based on the operation information and indicates a predetermined direction, to be displayed on a screen according to the stroke operation.

According to an embodiment of the present disclosure, as a stroke operation that is an operation of drawing a dot or a line extending in a predetermined direction using an operating body is performed, at least a candidate of a character corresponding to the stroke operation is displayed on a screen. Thus, a user can input at least a character with a simpler operation, and therefore user convenience can be boosted.

According to one or more embodiments of the present disclosure described above, user convenience can be further boosted. Note that the effect described above is not necessarily limiting, and along with or instead of the effect, any effect that is desired to be introduced in the present specification or other effects that can be expected from the present specification may be exhibited.

### BRIEF DESCRIPTION OF THE DRAWINGS

FIG. 1 is an illustrative diagram for describing correspondence relations between a stroke operation and characters;

FIG. 2 is a diagram showing a display example of a handwriting input GUI according to a first embodiment;

FIG. 3 is a diagram showing the display example of the handwriting input GUI according to the first embodiment;

FIG. 4 is a functional block diagram showing an example of a functional configuration of an information processing system according to the first embodiment of the present disclosure;

FIG. 5 is a flowchart showing an example of a process procedure of an information processing method according to the first embodiment;

FIG. 6 is a diagram showing one display example of a handwriting input GUI when display of the handwriting input GUI is switched and thereby a candidate display screen is displayed;

FIG. 7 is a diagram showing an example of a display screen of a handwriting input GUI for designating characters for each of consecutively input stroke operations;

FIG. 8 is a diagram showing an example of a display screen of a handwriting input GUI for selecting a word based on similar candidates;

FIG. 9 is a functional block diagram showing an example of a functional configuration in a modified example in which the information processing system according to the first embodiment is constituted by one information processing device;

FIG. 10 is a functional block diagram showing an example of functional configurations of information processing devices in another modified example in which the information processing system according to the first embodiment is constituted by the three information processing devices;

FIG. 11 is a functional block diagram showing an example of a functional configuration of an information processing system according to a second embodiment of the present disclosure;

FIG. 12 is a flowchart showing an example of a process procedure of an information processing method according to the second embodiment;

FIG. 13 is a flowchart showing an example of a process procedure of a selection process of a recognition method shown in FIG. 12;

FIG. 14 is a diagram showing one display example of a handwriting input GUI when candidates are narrowed down through a handwritten character input operation;

FIG. 15 is a functional block diagram showing an example of a functional configuration in a modified example in which the information processing system according to the second embodiment is configured by one information processing device;

FIG. 16 is a functional block diagram showing an example of a functional configuration in another modified example in which the information processing system according to the second embodiment is configured by three information processing devices;

FIG. 17 is an illustrative diagram for describing a difference in drawing a character according to users;

FIG. 18 is a functional block diagram showing an example of a functional configuration of an information processing system according to a modified example in which a stroke DB is updated;

FIG. 19 is a diagram showing one display example of a handwriting input GUI when a trace of an operating body is displayed on a display screen;

FIG. 20 is a diagram showing one display example of a handwriting input GUI when a history of input stroke operations is displayed on a display screen;

FIG. 21 is an illustrative diagram for describing a correspondence relation between a stroke operation and a number;

FIG. 22 is an illustrative diagram for describing another correspondence relation between a stroke operation and a number;

FIG. 23 is an illustrative diagram for describing a correspondence relation between a stroke operation and a letter of another language; and

FIG. 24 is a functional block diagram showing an example of a hardware configuration of the information processing device according to the first and second embodiments.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numbers, and repeated explanation of these structural elements is omitted.

Note that description will be provided in the following order.

1. First embodiment
1.1. Overview of a handwriting input process
1.2. Configuration of an information processing system
1.3. Process procedure of an information processing method
1.4. Candidate display example
1.5. Operation for narrowing down candidates
   1-5-1. Designation of letters included in a word
   1-5-2. Selection of a word based on similar candidates
   1.6. Modified examples of the configuration of the information processing system
   1-6-1. Modified example in which the information processing system is constituted by one information processing device
   1-6-2. Modified example in which the information processing system is constituted by three information processing devices
   2. Second embodiment
   2-1. Configuration of an information processing system
   2-2. Process procedure of an information processing method
   2-3. Candidate display example (an operation for narrowing down candidates)
   2-4. Modified examples of the configuration of the information processing system
   2-4-1. Modified example in which the information processing system is constituted by one information processing device
   2-4-2. Modified example in which the information processing system is constituted by three information processing devices
   3. Modified examples and display examples
   3-1. Updating of a stroke DB
   3-2. Display of a trace of an operating body
   3-3. Display of a history of input stroke operations
   3-4. Input of a number and a symbol
   3-5. Input of a character of another language
   4. Hardware configuration

### 5. Supplement

### 1. First Embodiment

First, a first embodiment of the present disclosure will be described. In the first embodiment and a second embodiment to be described later of the present disclosure, a process performed by a user to input letters, numbers, symbols, or the like to an information processing device such as a PC in handwriting (which will also be referred to hereinafter as a handwriting input process) is performed. In the first and second embodiments, a display screen relating to a graphical user interface (GUI) for the handwriting input process (which will also be referred to hereinafter as a handwriting input GUI) is displayed in a display unit of the information processing device. In addition, the information processing device is provided with an input interface that receives operation inputs of a user, and when the user inputs a stroke operation which is an operation of indicating a predetermined direction through the input interface, letters, numbers, symbols, or the like are input, and the input letters, numbers, symbols, or the like are displayed on the display screen of the handwriting input GUI.

In description below, a case in which a display unit of an information processing device is configured by a touch panel and a user inputs alphabetic characters (Latin letters) on a display screen of a handwriting input GUI displayed on the display unit using his or her finger as an operating body will be described as an example of the first embodiment and the second embodiment to be described later. In addition, a case in which the information processing device is a wristwatch-type wearable terminal (which will also be referred to hereinafter as a wristwatch-type terminal) will be exemplified. Since an input interface of the information processing device is a touch panel in the configuration example, as the user moves an operating body such as a stylus or a finger on a screen configured by the touch panel in a predetermined direction, a stroke operation indicating the direction is input, and thereby a letter, a number, a symbol, or the like is input thereto.

However, the first and second embodiments are not limited to this example. In the first and second embodiments, a letter, a number, a symbol, or the like is input when a user inputs a stroke operation that is an operation of indicating a predetermined direction to an information processing device as described above. Thus, an input interface of the information processing device may be configured by a device that can detect directions, and all sorts of devices can be applied as the input interface. For example, a display unit of the information processing device may not be configured by a touch panel, and stroke operations may be input by operating an operating body such as a cursor or a pointer within a display screen with a pointing device such as a mouse. In addition, the information processing device may be provided with a device such as a joystick, or a remote controller or a controller having direction keys as an input interface, and then stroke operations may be input through the device. In addition, the information processing device may be provided with various sensor devices that can detect motions of a user as an input interface, and then stroke operations may be input using, for example, motions (gestures) of a part of a body such as an arm or movements of a line of sight through the sensor device. Further, even when the display unit of the information processing device is configured by a touch panel, an operating body used to input letters and the like may not be a finger, and all sorts of operating bodies including a stylus may be used as long as positions thereof within the touch panel can be detected. An operating body may be adopted if coordinate information of the operating body within a display screen relating to a handwriting input GUI can be input, and a type thereof is not limited.

In addition, letters that can be input in the handwriting input process according to the first and second embodiments are not limited to Latin letters, and all sorts of characters of other languages, for example, katakana and hiragana of the Japanese language, and the like may be input. Furthermore, information that can be input is not limited to characters, and figures that have predetermined sounds or meanings with predetermined sets of dots and lines such as numbers, symbols, and the like may be input.

In addition, the information processing devices according to the first and second embodiments are not limited to a wristwatch-type terminal, and all sorts of information processing devices may be adopted as long as they are devices configured to realize all functions to be described later in [1-2. Configuration of an information processing system] and [2-1. Configuration of an information processing system] provided below. For example, the information processing devices may be other types of wearable terminals such as an eyeglass type. In addition, the information processing devices are not limited to wearable terminals, and may be mobile terminals such as smartphones, and tablet PCs, and may be stationary PCs, servers, and the like. Furthermore, all processes relating to the handwriting input process may not be performed by one information processing device, and an information processing system for executing a series of processes relating to the handwriting input process may be realized by a plurality of information processing devices.

[1-1. Overview of a Handwriting Input Process]

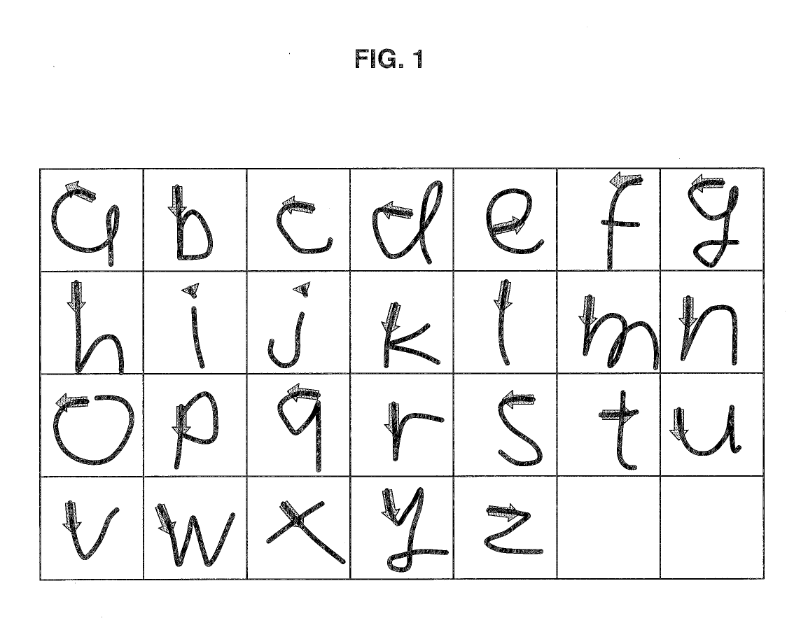

An overview of the handwriting input process according to the first embodiment of the present disclosure will be described with reference to FIGS. 1 to 3. As described above, when a user performs a stroke operation that is an operation of indicating a predetermined direction, a letter corresponding to the stroke operation can be input in the first embodiment. In that manner, in the handwriting input process according to the first embodiment, it is not necessary for a user to move an operating body so that all dots and lines constituting a letter are input, unlike, for example, general input of a handwritten character.

FIG. 1 shows an example of correspondence relations between a stroke operation and letters. FIG. 1 is an illustrative diagram for describing the correspondence relations between a stroke operation and letters. The 26 lowercase letters from a to z that are used in English are illustrated in FIG. 1. In addition, the stroke operations corresponding to the letters are illustrated superimposed on the letters in the form of arrows or triangles.

In the correspondence relations between the stroke operation and the letters of the example shown in FIG. 1, a predetermined letter is associated with a stroke operation corresponding to first drawing of a stroke when the letter is handwritten. For example, when an “a” is handwritten on a display screen with a finger, there are many cases of writing the letter in a way that the finger is first moved from a contact position of the display screen and the finger in the upper-left direction. Thus, an “a” is associated with the stroke operation indicating the upper-left direction as shown in FIG. 1. Likewise, a “b” is associated with a stroke operation indicating a downward direction. In addition, an “i” and a “j” are considered to be written from dots positioned in upper parts. Thus, the “i” and the “j” are associated with a stroke operation indicating dots. As described, a stroke operation is not limited to an operation indicating a direction, and may be an operation indicating a dot. Note that, in description to be provided below, a stroke operation indicating one predetermined direction will also be referred to as a stroke operation in that direction.

Here, the correspondence relations between the stroke operation and the letters shown in FIG. 1 are merely examples, and a different stroke operation from those shown in FIG. 1 may be associated with each letter. For example, drawing of strokes of a letter (an order of writing) is considered to differ between users. In the first embodiment, the correspondence relations between the stroke operation and the letters may be updated so as to deal with drawing strokes of a letter by a user who performs the handwriting input process. Note that updating of a correspondence relation between a stroke operation and a letter will be described in [3-1. Updating of a stroke DB] below in detail. In addition, in the first embodiment, a stroke operation in a predetermined direction may be associated with a predetermined letter, regardless of an order of writing the letter. An example of such association will be described in [3-4. Input of a number and a symbol] below.

Here, in the first embodiment, the same stroke operation can be assigned for a plurality of different letters as shown in FIG. 1. Thus, there is a possibility of one specific letter not being identified with input of one stroke operation. Therefore, in the first embodiment, candidates of a letter corresponding to the stroke operation are displayed based on the input stroke operation. In addition, when a plurality of stroke operations are consecutively input, based on a combination of the input stroke operations, candidates of a word appropriate for the combination may be displayed.

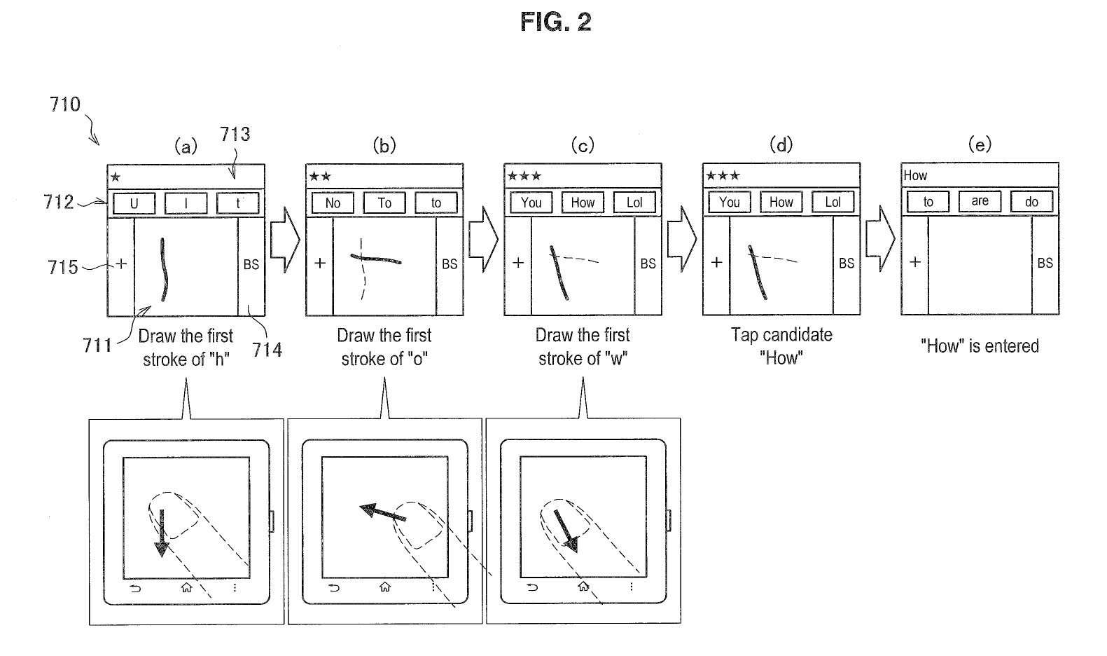

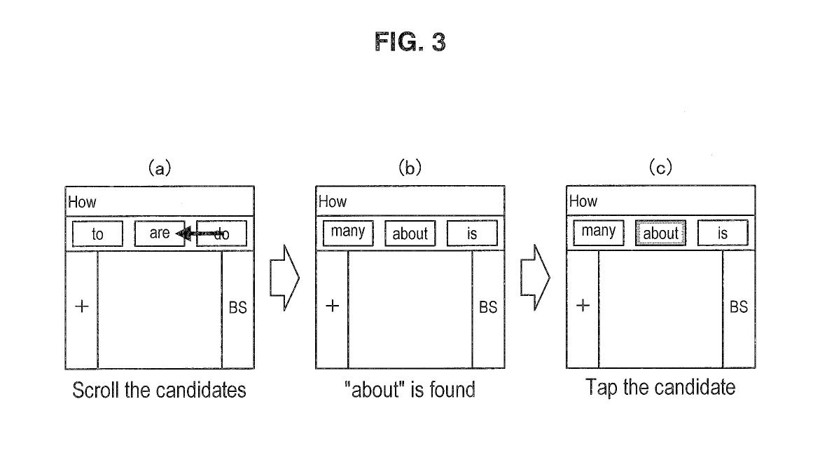

One display example of a handwriting input GUI according to the first embodiment will be described with reference to FIGS. 2 and 3. FIGS. 2 and 3 are diagrams showing the display example of the handwriting input GUI according to the first embodiment. In the FIGS. 2 and 3, the display example of the handwriting input GUI according to the first embodiment when a predetermined word is to be input is shown.

In FIG. 2, a transition of a display screen of the handwriting input GUI when the word “How” is input is shown as an example. Referring to FIG. 2, the display screen 710 of the handwriting input GUI has an input region 711, a candidate display region 712, a word display region 713, a backspace icon 714, and a menu icon 715.

The input region 711 is a region in which stroke operations are input by a user using an operating body. The candidate display region 712 is a region in which candidates are displayed according to input stroke operations. Here, candidates displayed in the candidate display region 712 may be one-letter candidates according to one input stroke operation, or word candidates according to a combination of stroke operations that are input consecutively. In addition, the word display region 713 is a region in which a word that is finally selected (input) by the user is displayed.

In addition, the backspace icon 714 is an icon for undoing input stroke operations. When the backspace icon 714 is selected by the operating body, for example, a previously input stroke operation is undone. The menu icon 715 is an icon for displaying a menu screen for changing various setting in the handwriting input process, for example, changing a type of a letter to be input and the like. When the menu icon 715 is selected by the operating body, for example, the menu screen for changing a setting is displayed.

When the word “How” is input, the user first performs an operation of moving his or her finger in the downward direction that is a stroke operation corresponding to an “h” (in other words, an operation of indicating the downward direction) in the input region 711 ((a) of the drawing). In the input region 711, for example, a trace of the operating body of the stroke operation is displayed as shown in (a) of FIG. 2. With the display of the trace, the user can intuitively grasp the stroke operation that he or she has input. Note that, when letters such as the Latin letters that have the concept of lowercase and uppercase letters are input in the handwriting input process according to the first embodiment, for example, with an input of one of the lowercase and uppercase letters, the candidate of the other letters may be displayed together. For example, when a stroke operation corresponding to a lowercase letter is input, the candidate of the uppercase letter corresponding to the lowercase letter can be displayed together. In the example shown in FIG. 2, the target word is “How,” and the first letter thereof is an “H,” but a letter to be input by the user through a stroke operation may be an “h.”

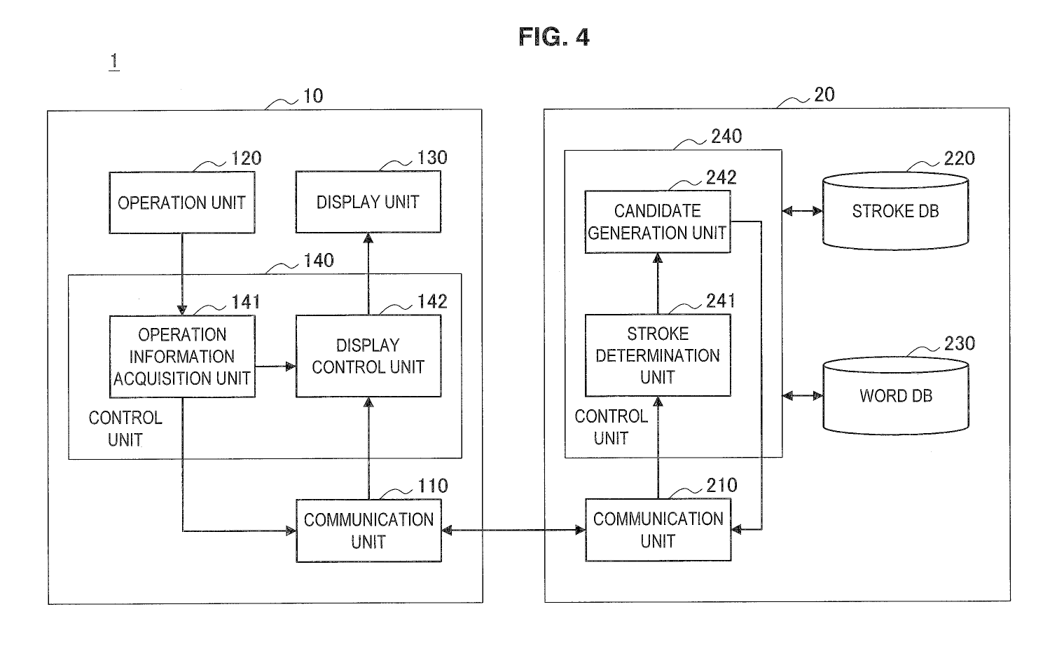

In the candidate display region 712, candidates according to an input stroke operation are displayed. Since only one stroke operation corresponding to “H” has been input in the stage shown in (a), candidates of the letter corresponding to the stroke operation are displayed in the candidate display region 712. In the example shown in FIG. 2, a “U,” an “I,” and a “t” are displayed as candidates of the letter corresponding to the stroke operation indicating the downward direction. In the first embodiment, for example, a database (DB) in which the correspondence relations between stroke operations and letters (for example, a stroke DB 220 shown in FIG. 4) is provided, and candidates of a letter corresponding to a stroke operation can be displayed when an information processing device accesses the DB.

In addition, in the word display region 713, a display for indicating an input of a first letter is performed. Since a letter or a word to be finally input has not yet been decided in the stage shown in (a), symbols that represent the number of letters to be input may be displayed on the word display region 713. In the example shown in (a) of FIG. 2, one star symbol corresponding to the number of letters to be input is displayed in the word display region 713.

Here, when there is a target letter among candidates displayed in the candidate display region 712, the user can select one of the candidates displayed and thereby can input the letter corresponding to the candidate. Since the case in which the word “How” is input is being exemplified, candidates of the target word are not displayed in the stage shown in (a) in which a stroke operation corresponding to the first letter has been input; however, when one certain letter is input, for example, the user may select a corresponding letter among candidates displayed in the candidate display region 712 in the stage shown in (a). In such a case, the letter corresponding to the selected candidate is displayed in the word display region 713 as a letter finally input.

Next, in the input region 711, the user performs an operation of moving his or her finger in the left direction (i.e., an operation indicating the left direction) which is a stroke operation corresponding to an “o” ((b) of the drawing). In the input region 711, for example, a trace of the operating body of the stroke operation that is newly input is displayed together with the trace of the operating body of the stroke operation that has been previously input displayed in pale as shown in (b) of FIG. 2. By displaying the trace of the operating body of the stroke operation that has been previously input, the user can grasp the history of stroke operations he or she has input.

Since the stroke operations corresponding to the “H” and the “o” are consecutively input in the stage shown in (b), word candidates corresponding to the combination of the stroke operations are displayed in the candidate display region 712. As candidates of sequences of letters corresponding to the combination of the stroke operation of the downward direction and the stroke operation of the left direction, “No,” “To,” and “to” are displayed in the example shown in (b) of FIG. 2. In addition, in the word display region 713, two star symbols are displayed to indicate that two letters have been input so far. In the first embodiment, for example, a DB in which words of a language which is an input target (for example, a word DB 230 shown in FIG. 4) is provided together with the above-mentioned stroke DB 220 shown in FIG. 4, and when an information processing device accesses the DBs, candidates of a word corresponding to a combination of stroke operations can be displayed.

Next, the user performs an operation of moving his or her finger in the lower-right direction (i.e., an operation indicating the lower-right direction) that is a stroke operation corresponding to a “w” in the input region 711 ((c) of the drawing). Likewise in (b) of FIG. 2, for example, a trace of the operating body of the stroke operation that has been previously input is displayed in pale along with the trace of the operating body of the stroke operation that is newly input in the input region 711.

In addition, since the stroke operations corresponding to the “H,” “o,” and “w” are consecutively input in the stage shown in (c), candidates of the word corresponding to the combination of the stroke operations are displayed in the candidate display region 712. In the example shown in FIG. 2, “You,” “How,” and “Lol” are displayed as candidates of the word corresponding to the combination of the stroke operation of the downward direction, the stroke operation of the left direction, and the stroke operation of the lower-right direction. In addition, in the word display region 713, three star symbols are displayed to indicate that three letters have been input so far.

In the stage shown in (c), the input up to the third letter is completed, and the target word “How” is displayed as a candidate. Thus, the user performs an operation of selecting “How” among the candidates displayed in the candidate display region 712 ((d) of the drawing). As operations of selecting “How,” various operations used when selecting a GUI component in a general GUI, for example, an operation of tapping a GUI component corresponding to “How” using a finger, and the like may be applied. When “How” has been selected, the selected “How” is displayed in the word display region 713 as a finally input word ((e) of the drawing).

Note that the order of candidates displayed in the candidate display region 712 can be decided according to a predetermined priority. For example, the order of displaying candidates in the candidate display region 712 may be an order of high use frequency, or letters or words which are used most recently may be displayed with higher priorities. Information of such priorities may be stored in, for example, the DB 230 shown in FIG. 4 in association with words.

After “How” is displayed in the word display region 713, the user performs the same operations as those shown in (a) to (e) of FIG. 2 for a word that he or she wants to input after “How.” Accordingly, a set of desired words, and further a sentence can be input.

Here, in the first embodiment, when any word is selected from displayed candidates and input, word candidates which are anticipated to follow the word in view of grammar are displayed on the display screen of a handwriting input GUI. By selecting a displayed candidate, the user can input the next word after the word that he or she has already input, without newly inputting letters one by one. FIG. 3 shows such transitions of the display screen of the handwriting input GUI when candidates of the next word are displayed in continuation of the input word and the next word is input from the candidates.

Referring to FIG. 3, when the word “How” has been input, candidates of the next word that can be input in continuation of “How” in view of grammar are displayed in the candidate display region 712 ((a) of the drawing). In the example shown in (a) of FIG. 3, “to,” “are,” and “do” are displayed as candidates of the next word to be input after “How.” In the first embodiment, for example, the above-mentioned word DB 230 shown in FIG. 4 may further store correspondence relations between given words and words which are anticipated to follow the words in view of the grammar of a target language. When an information processing device accesses the DB, candidates of the next word that follows an input word may be displayed.

Here, likewise with the example shown in FIG. 2, the candidates of the next word to be displayed in the candidate display region 712 may be displayed in an order according to a predetermined priority. For example, an order of displaying the candidates in the candidate display region 712 may be, for example, an order of words having high use frequencies following “How,” or words which are most recently used as words following “How” may be displayed with higher priorities. Information of such priorities may be stored in, for example, the above-mentioned word DB 230 shown in FIG. 4 in association with words.

As shown in (a) of FIG. 3, the candidates displayed in the candidate display region 712 can be scroll-displayed according to a user operation. As operations for scroll-displaying the candidates displayed in the candidate display region 712, various operations used in scrolling a display in a general GUI, for example, an operation of dragging a finger on the candidates in a direction in which the user wants to scroll and the like may be applied.

Herein, the user is assumed to consider inputting, for example, the word “about” after “How.” By scroll-displaying the candidates displayed in the candidate display region 712, the user can find the target word “about” ((b) of the drawing). Likewise when “How” is selected, the user performs an operation of selecting “about” from the candidates displayed in the candidate display region 712 ((c) of the drawing). Accordingly, “How about” is displayed in the word display region 713 as a set of words that are finally input.

The overview of the handwriting input process according to the first embodiment of the present disclosure has been described above with reference to FIGS. 1 to 3. By repeating the operation of inputting a word by inputting stroke operations for each letter as shown in (a) to (e) of FIG. 2 or the operation of inputting a word from candidates of the word displayed based on the input word as shown in (a) to (c) of FIG. 3, the user can input a set of desired words or a sentence.

As described above, by performing a stroke operation in the first embodiment, candidates of a letter or a word corresponding to the stroke operation are displayed, and a target letter or word can be input by selecting the candidate. Here, a stroke operation is an operation of indicating a predetermined direction, for example, an operation of drawing a line to extend in a predetermined direction using an operating body in the case of using a touch panel, and thus it is possible to input a letter with a simpler operation for a shorter period of time than, for example, in general handwriting character input for inputting a letter by drawing the entire shape of a letter. Therefore, convenience for a user is boosted.

Here, in a general handwriting character input, a complicated process is necessary for recognizing a handwritten character with higher accuracy, and thus there are cases in which a relatively long period of time of about several seconds taken to recognize one letter. In the first embodiment, a letter corresponding to an input stroke operation is recognized based on a simple correspondence relation between the stroke operation and the letter, and thus the letter can be recognized within a shorter period of time.

In addition, the handwriting input process according to the first embodiment can be preferably applied to a relatively small-sized information processing device that is represented by a wearable device. Such an information processing device such as a wearable device that is required to have high portability needs to have a miniaturized terminal, and an input interface (for example, a touch panel) with which a user inputs letters tends to be miniaturized. When a so-called qwerty keyboard that is used in general character inputs is displayed on a miniaturized touch panel and then letters are attempted to be input, for example, each key of the keyboard can be displayed extremely small, and thus it is hard to accurately select a desired key, and thus there is a high possibility of occurrence of input mistakes. In addition, when general handwriting character input is attempted on a miniaturized touch panel, a complicated operation of drawing the entire shape of a letter in a narrow input region is necessary, and thus user operability is not high by any means. On the other hand, in the handwriting input process according to the first embodiment, letters can be input through simpler operation inputs which are stroke operations, and therefore letters can be input with higher accuracy and higher operability even in an information processing device of which an input interface is miniaturized.

Here, as a technology of inputting letters through a simpler operation input than the general handwriting character input, there is Graffiti which has been developed by Palm, Inc. In Graffiti, a predetermined simplified figure and a letter are associated with each other, and when the figure is input, the letter is input accordingly. In Graffiti, however, the correspondence relation between the figure and the character is unilaterally given from a system side, and thus, when a user inputs the character using Graffiti, it is necessary to remember the correspondence relation. Thus, it takes a relatively long period of time to learn how to input characters using Graffiti. On the other hand, in the correspondence relations between stroke operations and letters in the first embodiment, a predetermined letter may be associated with a stroke operation corresponding to drawing a stroke when the letter is handwritten. Accordingly, users do not have to remember stroke operations corresponding to each letter, and can perform stroke operations for inputting letters based on senses that they generally feel when writing the letter, and thus can learn how to input letters through stroke operations within a shorter period of time, and therefore the time taken to input letters can be further shortened.

[1-2. Configuration of an Information Processing System]

Next, a functional configuration of an information processing system for realizing the handwriting input process described above will be described. The functional configuration of the information processing system according to the first embodiment of the present disclosure will be described with reference to FIG. 4. FIG. 4 is a functional block diagram showing an example of the functional configuration of the information processing system according to the first embodiment of the present disclosure.

Here, the handwriting input process according to the first embodiment may be executed by a single information processing device as described above, or may be executed with the cooperation of a plurality of information processing devices. FIG. 4 illustrates the functional configuration of the information processing system when the handwriting input process is executed by an information processing system constituted by a plurality of information processing devices, as an example of the first embodiment. Note that a case in which the information processing system is realized with a different configuration will be described in [1-6. Modified examples of the configuration of the information processing system] later in detail.

Referring to FIG. 4, the information processing system 1 according to the first embodiment includes a wristwatch-type terminal 10 and a portable-type terminal 20. The wristwatch-type terminal 10 is an example of an information processing device worn and used by a user (a so-called wearable terminal). In addition, the portable-type terminal 20 is an example of an information processing device appropriate for users to carry, which includes, for example, a smartphone, or a tablet PC. The wristwatch-type terminal 10 and the portable-type terminal 20 can be realized by information processing devices with, for example, the hardware configuration to be described in <4. Hardware configuration> below.

In the information processing system 1, the handwriting input process according to the first embodiment is executed as the wristwatch-type terminal 10 and the portable-type terminal 20 transmit and receive various kinds of information with each other via a network (not illustrated). As a communication scheme between the wristwatch-type terminal 10 and the portable-type terminal 20, for example, one based on a communication standard such as Bluetooth (a registered trademark) or Wi-Fi (a registered trademark) can be applied.

First, a functional configuration of the wristwatch-type terminal 10 will be described. The wristwatch-type terminal 10 includes a communication unit 110, an operation unit 120, a display unit 130, and a control unit 140.

The communication unit 110 is a communication interface for connecting the wristwatch-type terminal 10 to another external device so that the devices can communicate with each other. The wristwatch-type terminal 10 can transmit and receive various kinds of information with the portable-type terminal 20 through the communication unit 110. In the first embodiment, the communication unit 110 transmits operation information that is information regarding an operation input by a user including coordinate information of an operating body acquired by an operation information acquisition unit 141 of the control unit 140 to be described later to the portable-type terminal 20. The communication unit 110 can receive candidate information regarding candidates of a letter or a word associated with a stroke operation generated based on the operation information from the portable-type terminal 20. Further, the communication unit 110 may transmit operation information indicating a word finally selected by a user from displayed candidates acquired by the operation information acquisition unit 141 of the control unit 140 to be described later to the portable-type terminal 20. The communication unit 110 can receive candidate information regarding candidates of a word to be input next generated based on the operation information indicating the finally selected word from the portable-type terminal 20.

The operation unit 120 is an input interface for detecting various operation inputs by the user performed with respect to the wristwatch-type terminal 10. The user can input various kinds of information and instructions to the wristwatch-type terminal 10 through the operation unit 120. The operation unit 120 is configured by a touch panel in the first embodiment. The operation unit 120, however, may be configured to include various other input devices, for example, a mouse, a keyboard, buttons, and the like. The operation unit 120 provides operation information that is information regarding operation inputs by the user to the operation information acquisition unit 141 of the control unit 140 to be described later.

The display unit 130 is an output interface for notifying a user of various kinds of information by displaying the information on a display screen in various forms of text, images, charts, graphs, and the like. The display unit 130 is configured by any of various kinds of display devices, for example, a liquid crystal display (LCD), an organic electro-luminescence (EL) display, and the like. Since the operation unit 120 is configured by a touch panel in the first embodiment, the operation unit 120 and the display unit 130 may be integrally configured. The display unit 130, however, may not be configured by a touch panel, and may have a different configuration from the operation unit 120. The display unit 130 can display a display screen relating to the handwriting input GUI for performing the handwriting input process as exemplified in FIGS. 2 and 3 under control from a display control unit 142 of the control unit 140 to be described later.

The control unit 140 is configured by any of various kinds of processors, for example, a central processing unit (CPU), a digital signal processor (DSP), and the like, and controls various processes performed in the wristwatch-type terminal 10. The control unit 140 has the operation information acquisition unit 141 and the display control unit 142. The function of the control unit 140 including the functions thereof is realized when, for example, the processor included in the control unit 140 operates according to a predetermined program.

The operation information acquisition unit 141 acquires the operation information that is information regarding operation inputs input by the user through the operation unit 120. To be specific, the operation information acquisition unit 141 can acquire operation information at least indicating stroke operations by the user input through the operation unit 120. In the first embodiment, the operation information acquisition unit 141 can acquire information regarding various operation inputs performed by a finger on the display screen of the handwriting input GUI described with reference to FIGS. 2 and 3. For example, the operation information includes coordinate information of the operating body within the display screen of the handwriting input GUI. In addition, when a position of the operating body is moved within the display screen, the operation information may also include information regarding a change of the coordinate information indicating a trace of the movement of the operating body. The coordinate information can be information indicating, for example, a position of the operating body in a stroke operation input by the user on the display screen of the handwriting input GUI. Note that the coordinate information is an example of the operation information that can indicate a stroke operation when the operation unit 120 is configured by a touch panel. When a stroke operation is input through another input interface, the operation information acquisition unit 141 may acquire information regarding an operation input indicating the stroke operation input through the other input interface as operation information.

Further, the operation information can include information indicating, for example, operations of movement, selection, and the like of various icons displayed on the display screen of the handwriting input GUI as GUI components. Here, when the operation unit 120 includes a pointing device such as a mouse, for example, the operations of movement, selection, and the like of various icons displayed as GUI components can be executed using the operating body such as a cursor, a pointer, or the like displayed on the display screen of the handwriting input GUI. In addition, when the operation unit 120 includes a touch panel, the operations of movement, selection, and the like of an icon can be directly executed through contact of a finger of the user, a stylus, or the like thereto. Note that the operation information acquisition unit 141 can acquire not only various kinds of information input with the handwriting input GUI but also all kinds of information that can be input through the operation unit 120 of a general information processing device, for example, information relating to button operations for activating and shutting down the wristwatch-type terminal 10.

The operation information acquisition unit 141 transmits the acquired operation information including the coordinate information of the operating body within the display screen of the handwriting input GUI to the portable-type terminal 20 through the communication unit 110. In addition, the operation information acquisition unit 141 may provide the coordinate information to the display control unit 142. Further, the operation information acquisition unit 141 provides information relating to a change of the display screen of the handwriting input GUI out of the acquired operation information (for example, information regarding the operation for scroll-displaying candidates displayed in the candidate display region 712, information regarding an operation of selecting a candidate displayed in the candidate display region 712, and the like described with reference to FIGS. 2 and 3) to the display control unit 142.

The display control unit 142 controls the display unit 130 to cause various kinds of information to be displayed on the display unit 130. In the first embodiment, the display control unit 142 causes, for example, the display screen relating to the handwriting input GUI for performing the handwriting input process as shown in FIGS. 2 and 3 to be displayed on the display unit 130. The display control unit 142 can perform various kinds of control display with respect to the handwriting input GUI described with reference to FIGS. 2 and 3 such as moving display of a pointer in the handwriting input GUI or changing display of the handwriting input GUI based on, for example, the operation information acquired by the operation information acquisition unit 141. For example, the display control unit 142 can perform control of causing a trace of the operating body in a stroke operation to be displayed on the display screen based on the coordinate information provided from the operation information acquisition unit 141. In addition, based on the operation information provided from the operation information acquisition unit 141, for example, the display control unit 142 can cause candidates displayed in the candidate display region 712 to be scroll-displayed. Further, based on the operation information provided from the operation information acquisition unit 141, for example, the display control unit 142 can cause a letter or a word selected from the candidates displayed in the candidate display region 712 to be displayed in the word display region 713. Note that the display control unit 142 can perform not only various kinds of display control in the handwriting input GUI but also various kinds of display control that can be performed in a general information processing device, for example, causing a screen of a desk-top to be displayed on the display unit 130.

The functional configuration of the wristwatch-type terminal 10 has been described above. Next, a functional configuration of the portable-type terminal 20 will be described. The portable-type terminal 20 includes a communication unit 210, the stroke DB 220, the word DB 230, and a control unit 240.

The communication unit 210 is a communication interface for connecting the portable-type terminal 20 to another external device so that the devices can communicate with each other. The portable-type terminal 20 can transmit and receive various kinds of information with the wristwatch-type terminal 10 through the communication unit 210. In the first embodiment, the communication unit 210 receives the operation information including the coordinate information of the operating body within the display screen from the wristwatch-type terminal 10. The communication unit 210 can transmit candidate information regarding candidates of a letter or a word corresponding to a stroke operation generated by a candidate generation unit 242 of the control unit 240 to be described later based on the operation information to the wristwatch-type terminal 10. Further, the communication unit 210 may receive operation information indicating a word finally selected by the user from the displayed candidates from the wristwatch-type terminal 10. The communication unit 210 can transmit candidate information regarding candidates of a word to be input next generated by the candidate generation unit 242 based on the operation information indicating the finally selected word to the wristwatch-type terminal 10.

The stroke DB 220 is a storage unit configured by a storage device, for example, a magnetic storage device, a semiconductor storage device, or the like, in which predetermined information is temporarily or permanently stored. The stroke DB 220 is a database in which correspondence relations of stroke operations and letters are stored. Here, a correspondence relation between a stroke operation and a letter may be a correspondence relation between a predetermined letter and a stroke operation corresponding to drawing a stroke when the letter is handwritten as exemplified in FIG. 1. The candidate generation unit 242 of the control unit 240 to be described later can generate candidates of a letter corresponding to an input stroke operation with reference to the stroke DB 220.

Here, drawing strokes of a letter (a drawing order) is considered to differ depending on users as described above. In the first embodiment, the content of the stroke DB 220, i.e., the correspondence relations between stroke operations and letters may be updated so as to deal with drawing strokes of letters of users who perform the handwriting input process. Updating of the stroke DB 220 will be described in [3-1. Updating of a stroke DB] below in detail.

The word DB 230 is a storage unit configured by a storage device, for example, a magnetic storage device, a semiconductor storage device, or the like, in which predetermined information is temporarily or permanently stored. The word DB 230 is a database in which words of a language which is an input target are stored. Based on a combination of stroke operations which are consecutively input, the candidate generation unit 242 of the control unit 240 to be described later can generate candidates of a word corresponding to the combination with reference to the stroke DB 220 and the word DB 230.

In addition, the word DB 230 may further store correspondence relations of predetermined words and words which are anticipated to follow the words in view of grammar in the input target language. In the example described with reference to FIG. 2, as words which are anticipated to grammatically follow the word “How,” for example, words of “to,” “are,” “many,” “about,” and the like are stored in the word DB 230. Based on a word that is finally selected by the user from displayed candidates, the candidate generation unit 242 of the control unit 240 to be described later can generate candidates of a word that is anticipated to follow the word with reference to the word DB 230.

The control unit 240 is configured by any of various processors, for example, a CPU, a DSP, or the like, and controls various processes performed in the portable-type terminal 20. The control unit 240 has a stroke determination unit 241 and the candidate generation unit 242. The function of the control unit 240 including the functions thereof is realized when, for example, the processor included in the control unit 240 operates according to a predetermined program.

The stroke determination unit 241 determines an input stroke operation based on the operation information including the coordinate information of the operating body acquired by the operation information acquisition unit 141 of the wristwatch-type terminal 10. Here, determination of a stroke operation may be a process of specifying content of the stroke operation. For example, the stroke determination unit 241 can determine whether an input stroke operation is an operation of indicating a direction or an operation of indicating a point. In addition, when the input stroke operation is an operation of indicating a direction, the stroke determination unit 241 can determine a direction of the stroke operation. To be specific, the stroke determination unit 241 can determine content of the input stroke operation based on the coordinate information of the operating body acquired by the operation information acquisition unit 141. The stroke determination unit 241 provides information of a determination result of the stroke operation to the candidate generation unit 242.

Based on the determination result of the stroke operation by the stroke determination unit 241, the candidate generation unit 242 generates at least candidates of a letter corresponding to the stroke operation. For example, referring to the stroke DB 220, for example, the candidate generation unit 242 can generate candidates of a letter corresponding to the input stroke operation. In addition, when the stroke determination unit 241 has determined a plurality of stroke operations which are consecutively input, based on a combination of the plurality of stroke operations, the candidate generation unit 242 may generate candidates of a word corresponding to the combination. Referring to the stroke DB 220 and the word DB 230, for example, the candidate generation unit 242 can generate candidates of a word corresponding to a combination of input stroke operations.

In addition, the candidate generation unit 242 may acquire the operation information indicating a word finally selected by the user from displayed candidates acquired by the operation information acquisition unit 141 of the wristwatch-type terminal 10 through the communication unit 210. Referring to the word DB 230, the candidate generation unit 242 can generate candidates of a word that is anticipated to grammatically follow the finally selected word based on the operation information.

The candidate generation unit 242 provides candidate information regarding generated candidates of a letter or a word to the communication unit 210. The candidate information is transmitted to the display control unit 142 of the wristwatch-type terminal 10 through the communication unit 210. The display control unit 142 can cause the candidates of the letter or the word to be displayed on the display screen of the handwriting input GUI based on the candidate information.

Note that, in the stroke DB 220 and the word DB 230, information regarding the priorities for displaying the candidates of the letter and the word in the handwriting input GUI may be stored in association with the letters and the words. The priority may be, for example, an order of high use frequencies, or letters or words which are most recently used may be set to have higher priorities. When generating the candidates of letters and words, the candidate generation unit 242 may acquire the information of the priorities from the stroke DB 220 and the word DB 230, and then transmit the candidate information including the information regarding the priorities to the wristwatch-type terminal 10. Based on the information regarding the priorities, the display control unit 142 of the wristwatch-type terminal 10 can cause candidates of a letter or a word to be displayed on the display screen of the handwriting input GUI according to a predetermined priority.

The functional configuration of the information processing system 1 according to the first embodiment has been described above. As described above, the operation information acquisition unit 141 acquires the operation information at least indicating a stroke operation performed by the user in the information processing system 1 according to the first embodiment. Then, based on the operation information, candidates of a letter corresponding to the input stroke operation are generated by the candidate generation unit 242, and presented to the user. Since the user can input letters through simpler operations as above, user convenience can be boosted.

In addition, in the first embodiment, by linking the wristwatch-type terminal 10 and the portable-type terminal 20 to each other, the series of processes of the handwriting input process are executed. Then, the portable-type terminal 20 performs processes of searching the DBs and then generating candidates which cause a relatively heavy load thereon. Here, since the wristwatch-type terminal 10 is worn and used by the user, a greatly-sized configuration thereof is not preferable in view of wearability. In the first embodiment, since the processes with a relatively heavy load are performed by the portable-type terminal 20 rather than the wristwatch-type terminal 10, the handwriting input process can be executed without increasing the size of the configuration of the wristwatch-type terminal 10.

[1-3. Process Procedure of an Information Processing Method]

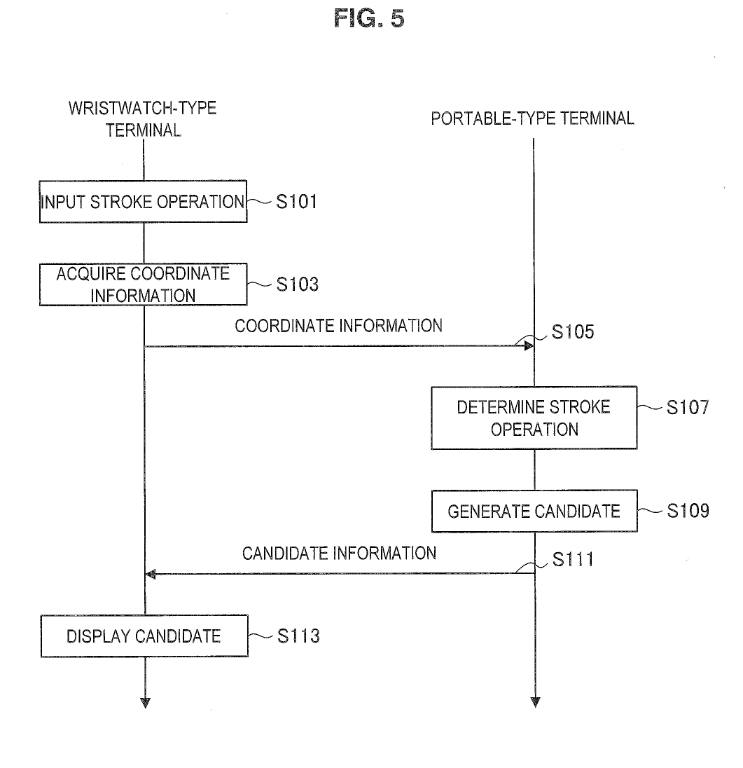

Next, a process procedure of an information processing method according to the first embodiment will be described with reference to FIG. 5. FIG. 5 is a flowchart showing an example of the process procedure of the information processing method according to the first embodiment. A series of processes performed in the information processing method correspond to the series of processes performed in the handwriting input process according to the first embodiment, and can be realized with, for example, the functional configuration of the information processing system 1 shown in FIG. 4.

Referring to FIG. 5, in the information processing method according to the first embodiment, a user first inputs a stroke operation into the wristwatch-type terminal 10 (Step S101). The process shown in Step S101 may specifically be a process of the user performing a stroke operation within the display screen of the handwriting input GUI.

Next, the wristwatch-type terminal 10 acquires coordinate information of the operating body with respect to the stroke operation input in Step S101 (Step S103). The process shown in Step S103 corresponds to a process of the wristwatch-type terminal 10 acquiring the operation information indicating the stroke operation performed by the user. The process may specifically be a process of the operation information acquisition unit 141 of the wristwatch-type terminal 10 acquiring operation information including the coordinate information of the operating body with respect to the stroke operation.

The operation information including the coordinate information acquired in Step S103 is transmitted to the portable-type terminal 20 from the wristwatch-type terminal 10 through, for example, the communication units 110 and 210 described above (Step S105).

Next, the portable-type terminal 20 determines the input stroke operation based on the operation information (Step S107). The process shown in Step S107 may specifically be a process of the stroke determination unit 241 of the portable-type terminal 20 determining the content of the input stroke operation based on the coordinate information of the operating body acquired by the operation information acquisition unit 141 of the wristwatch-type terminal 10.

Next, the portable-type terminal 20 generates candidates corresponding to the stroke operation based on a determination result of the stroke operation of Step S107 (Step S109). The process shown in Step S109 may be a process of the candidate generation unit 242 of the portable-type terminal 20 generating candidates of a letter corresponding to the stroke operation based on the determination result of the stroke operation. In addition, when a plurality of consecutively input stroke operations have been determined in Step S107, based on a combination of the plurality of stroke operations, candidates of a word corresponding to the combination may be generated in Step S109.

Candidate information regarding the candidates generated in Step S109 is transmitted to the wristwatch-type terminal 10 from the portable-type terminal 20 through, for example, the communication units 110 and 210 (Step S111).

Next, the wristwatch-type terminal 10 displays candidates of the letter or the word corresponding to the input stroke operation based on the candidate information (Step S113). The process shown in Step S113 may specifically be a process of the display control unit 142 of the wristwatch-type terminal 10 causing the candidates of the letter or the word corresponding to the input stroke operation to be displayed on the display screen of the handwriting input GUI based on the candidate information.

The process procedure of the information processing method according to the first embodiment has been described hereinabove with reference to FIG. 5. Here, FIG. 5 shows the process procedure when the information processing method is realized with the configuration of the information processing system 1 shown in FIG. 4 as an example of the process procedure of the information processing method according to the first embodiment. A process procedure of the information processing method according to the first embodiment is not limited to the example shown in FIG. 5, and a terminal that performs each of the processes shown in Step S101 to Step S113 may be appropriately changed according to the configuration of the information processing system 1.

[1-4. Candidate Display Example]

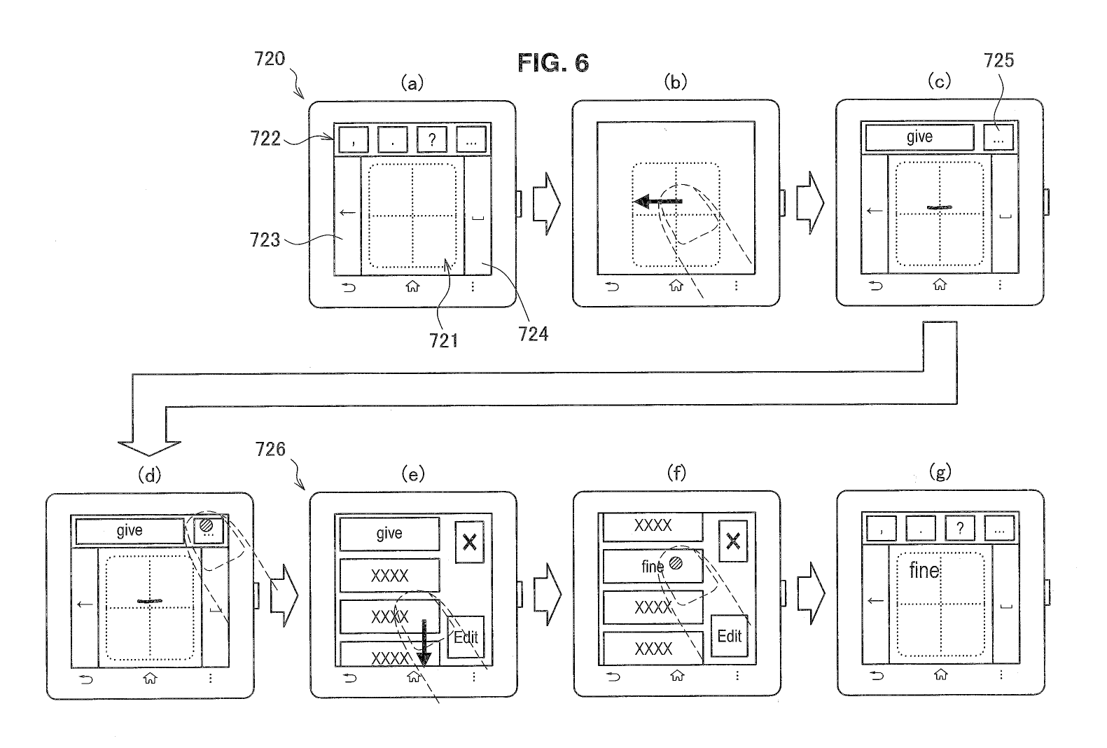

As described in [1-1. Overview of a handwriting input process] above with reference to FIGS. 2 and 3, candidates of a letter or a word corresponding to an input stroke operation are displayed in the handwriting input GUI according to the first embodiment. Such display of candidates in the handwriting input GUI, however, is not limited to the example shown in FIGS. 2 and 3. Herein, another example of candidate display in the handwriting input GUI according to the first embodiment will be described with reference to FIG. 6. Note that a series of processes described with reference to FIG. 6 can be realized with, for example, the functional configuration of the information processing system 1 shown in FIG. 4. For example, display of the handwriting input GUI shown in FIG. 6 can be controlled by the display control unit 142 of the wristwatch-type terminal 10 shown in FIG. 4 and performed on the display unit 130.

In the example shown in FIGS. 2 and 3, candidates of a word are displayed in the candidate display region 712 of the display screen 710 of the handwriting input GUI, and the user can search for a desired word by causing the candidates of the word displayed in the candidate display region 712 to be scroll-displayed. In the case of a terminal with quite a small-sized screen, for example, the wristwatch-type terminal 10, however, the number of candidates of a word that can be displayed at the same time within the screen is relatively small. Accordingly, when there are many words to be generated as candidates, there is a possibility of a desired word being difficult to find. Thus, in order to boost user convenience of selecting a target word from candidate words, display of the handwriting input GUI may be switched as needed between a first display state in which the input region in which stroke operations are input and candidates corresponding to the stroke operations are displayed together and a second display state in which the candidates are displayed in the form of a list without the input region displayed. In description provided below, the display screen in the second display state will also be referred to as a candidate display screen because it is a screen on which candidates are mainly displayed.

With reference to FIG. 6, a display example of the handwriting input GUI when display of the handwriting input GUI is switched and thereby the candidate display screen is displayed as described above will be described. FIG. 6 is a diagram showing the display example of the handwriting input GUI when display of the handwriting input GUI is switched and thereby the candidate display screen is displayed. In FIG. 6, transitions of the display screen of the handwriting input GUI when a user intends to input the word “fine” are shown as an example.

Referring to FIG. 6, a display screen 720 in the first display state is first displayed as the display screen of the handwriting input GUI ((a) of the drawing). The display screen 720 has an input region 721, a candidate display region 722, a backspace icon 723, and a space icon 724.

Here, the input region 721 is a region corresponding to the input region 711 shown in FIGS. 2 and 3, in which the user inputs stroke operations. The candidate display region 722 is a region corresponding to the candidate display region 712 shown in FIGS. 2 and 3, in which candidates corresponding to input stroke operations are displayed. The backspace icon 723 is an icon corresponding to the backspace icon 714 shown in FIGS. 2 and 3, for undoing previously input stroke operations. The space icon 724 is an icon corresponding to a space key of a keyboard, for inputting spaces. Note that, on the display screen 720 of the example shown in FIG. 6, a region and an icon each corresponding to the word display region 713 and the menu icon 715 shown in FIGS. 2 and 3 are not provided, however, the display screen 720 may further have a region and an icon corresponding to the word display region 713 and the menu icon 715.

The user sequentially inputs stroke operations (for example, a stroke operation in the left direction, a stroke operation indicating a dot, a stroke operation in the downward direction, and an stroke operation in the right direction) corresponding to the word “fine” that he or she wants to input in the input region 721 of the display screen 720 ((b) of the drawing). Then, candidates of the word corresponding to the combination of the input stroke operations are displayed in the candidate display region 722 ((c) of the drawing). In the example shown in (c) of FIG. 6, “give” is displayed in the candidate display region 722 as a candidate of the word.

Here, since the user wants to input the word “fine,” it is necessary to search for “fine” from candidates displayed in the candidate display region 722. As in the example shown in FIG. 3, it is also possible to search for “fine” by scroll-displaying the candidates displayed in the candidate display region 722, however, in the present display example, display of the handwriting input GUI can be switched to the second display state that further facilitates selection of a candidate.

For example, a transition icon 725 for transitioning from the first display state to the second display state is displayed within the display screen 720 as shown in (c) of FIG. 6. When the user judges that it is not easy to find the target word “fine” from the candidates displayed in the candidate display region 722, he or she selects the transition icon 725 ((d) of the drawing).

When the transition icon 725 is selected, the display screen 720 is transitioned to a candidate display screen 726 that is the display screen in the second display state ((e) of the drawing). On the candidate display screen 726, the input region 721 is not displayed and candidates of the word corresponding to a combination of the input stroke operations are displayed in the form of a list as shown in (e) of FIG. 6. The candidates displayed on the candidate display screen 726 can be scroll-displayed according to a user operation input. When the user finds the target word “fine” from the scroll-displayed candidates, he or she can select the word “fine” ((f) of the drawing). Since the input region 721 is not provided and thus candidates of a word are displayed in a wider region on the candidate display screen 726 as shown in (e) and (f) of FIG. 6, a larger number of candidates can be displayed at the same time, and thus the user can more easily find a target word.

When the word is selected, the display of the handwriting input GUI returns to the first display state, thereby transitioning to the display screen 720 ((g) of the drawing). As shown in (g) of FIG. 6, the word finally selected by the user may also be displayed on the display screen 720. In the example shown in (g) of FIG. 6, the word “fine” selected on the candidate display screen 726 is displayed as a background of the display screen 720.

The display example of the handwriting input GUI when display of the handwriting input GUI is switched and thereby the candidate display screen is displayed has been described above with reference to FIG. 6. By switching the display of the handwriting input GUI in the present display example, the input region 721 is not provided and the candidate display screen 726 on which a larger number of candidates are displayed on one screen at the same time is displayed as described above. Using the candidate display screen 726, the user can more easily find his or her target word, and accordingly input words more efficiently. Note that the case in which candidates of a word are displayed has been shown in FIG. 6, however, also when the user inputs one stroke operation and candidates of a letter are displayed, the candidate display screen 726 in which the candidates of the letter corresponding to the input stroke operation are displayed in the form of a list may be displayed, without displaying the input region 721.

[1-5. Operation for Narrowing Down Candidates]

As described in [1-1. Overview of a handwriting input process] above with reference to FIGS. 2 and 3, candidates of a word corresponding to a combination of input stroke operations may be displayed in the handwriting input GUI according to the first embodiment. Here, the candidates of the word can be displayed in an order of a predetermined priority, for example, an order of higher use frequencies as described above. However, when a target word of a user has a low priority, for example, there are cases in which the user has difficulty finding his or her target word from displayed candidates. Thus, when it is difficult to find a target word in the first embodiment, the user may perform a predetermined operation for narrowing down candidates.

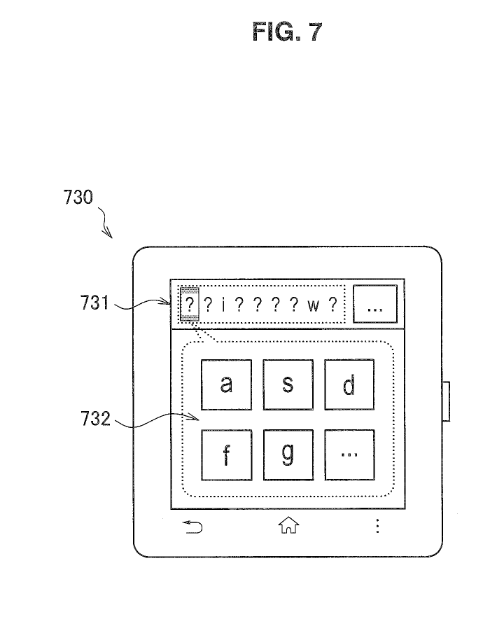

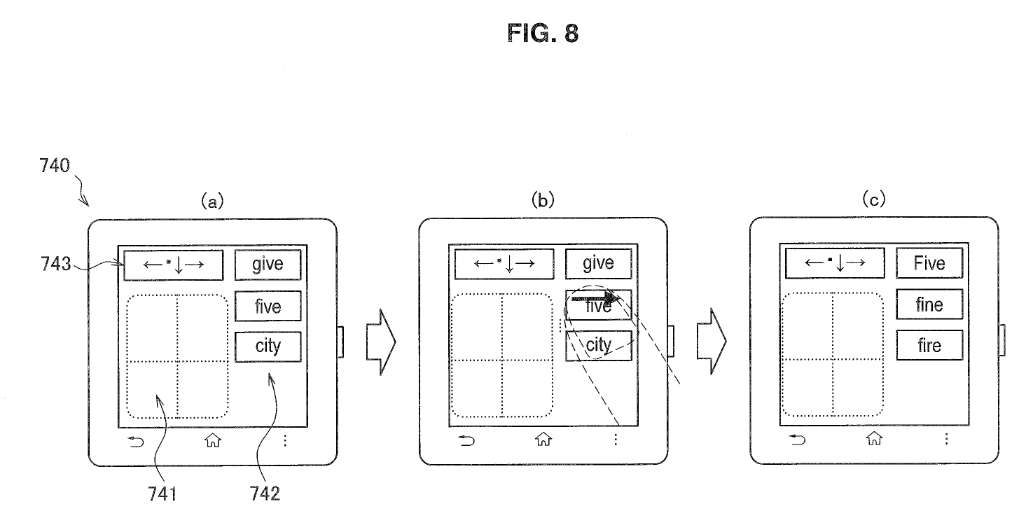

Herein, several display examples of the handwriting input GUI according to the first embodiment when the operation for narrowing down candidates is performed will be described with reference to FIGS. 7 and 8. Note that a series of processes to be described with reference to FIGS. 7 and 8 can be realized with, for example, the functional configuration of the information processing system 1 shown in FIG. 4. For example, display of the handwriting input GUI shown in FIGS. 7 and 8 can be controlled by the display control unit 142 of the wristwatch-type terminal 10 shown in FIG. 4, and performed on the display unit 130.

(1-5-1. Designation of Letters Included in a Word)

In the handwriting input GUI according to the first embodiment, after stroke operations are consecutively input, a display screen for designating letters for each of the consecutively input stroke operations may be displayed as a display screen for performing the operation for narrowing down candidates. An example of such a display screen of the handwriting input GUI for designating letters for each of consecutively input stroke operations will be described with reference to FIG. 7. FIG. 7 is a diagram showing an example of the display screen of the handwriting input GUI for designating letters for each of consecutively input stroke operations.

Referring to FIG. 7, a display screen 730 of the handwriting input GUI for designating letters for each of consecutively input stroke operations has a word display region 731 and a character designation region 732. The display screen 730 may be displayed when a user performs a predetermined switching operation such as selecting, for example, a screen switching icon on a display screen (for example, the display screen 720 shown in FIG. 3) which is for selecting a desired word from displayed candidates.

The word display region 731 is a region corresponding to the word display region 713 shown in FIGS. 2 and 3, in which a word finally selected by a user is displayed. Since a final word has not yet been selected on the display screen 730 in the example shown in FIG. 7, the symbols of “?” are displayed in the portion corresponding to input letters of the word.

The character designation region 732 is a region in which letters included in the word are designated for each of stroke operations. In the character designation region 732, letter candidates corresponding to each of consecutively input stroke operations are displayed. For example, a user selects a letter that he or she wants to designate out of a sequence of letters indicating the word that is displayed in the word display region 731. In the character designation region 732, letter candidates according to stroke operations which correspond to the selected letter are displayed. In the example shown in FIG. 7, a “?” indicating a first letter has been selected from the sequence of letters indicating the word displayed in the word display region 731. When, for example, a stroke operation is input in the left direction for a first letter, an “a,” an “s,” a “d,” an “f,” and a “g” which are letter candidates corresponding to the stroke operation are displayed in the character designation region 732 as shown in FIG. 7. Note that the order of displaying letters in the character designation region 732 may be decided according to a predetermined priority, for example, an order of higher use frequencies, or the like.

As the user selects a desired letter from the letters displayed in the character designation region 732, a corresponding letter included in the word is confirmed. In the portion corresponding to the confirmed letter in the sequence of letters indicating the word displayed in the word display region 731, the corresponding letter is displayed. For example, in the sequence of the letters indicating the word displayed in the word display region 731 of the example shown in FIG. 7, an “i” and a “w” are displayed as confirmed letters. By repeating the operation of designating letters included in a word one by one in that manner, the user can input his or her desired word.

The example of the display screen of the handwriting input GUI for designating letters for each of consecutively input stroke operations has been described above with reference to FIG. 7. After stroke operations are consecutively input, the operation of designating letters for each of the consecutively input stroke operations may be performed in the first embodiment as described above. By designating letters for each of stroke operations in this manner, it is possible to input even words that are not included in the word DB, for example, special proper nouns.

Note that the series of processes described with reference to FIG. 7 is a process in which stroke operations are consecutively input, and then, for a word corresponding to a combination of the stroke operations, letters included in the word are designated again, and thus it can be referred to as a process of re-inputting letters. The display screen 730 shown in FIG. 7 is a display screen relating to a re-input mode for re-inputting letters, having a different function from the display screen relating to a normal input mode as shown in, for example, FIGS. 2 and 3. In the first embodiment, a word can be input while the user appropriately switches the normal input mode and the re-input mode through, for example, a switching operation in this manner as needed, and thus the user can more easily reach his or her desired word.

(1-5-2. Selection of a Word Based on Similar Candidates)

In the handwriting input GUI according to the first embodiment, a display screen for selecting a word based on similar candidates may be displayed as a display screen for performing an operation for narrowing down candidates. An example of the display screen of the handwriting input GUI for selecting a word based on similar candidates will be described with reference to FIG. 8. FIG. 8 is a diagram showing the example of the display screen of the handwriting input GUI for selecting a word based on similar candidates.

Referring to FIG. 8, a display screen 740 of the handwriting input GUI for selecting a word based on similar candidates has an input region 741, a candidate display region 742, and a stroke history display region 743. The input region 741 is a region corresponding to the input region 711 shown in FIGS. 2 and 3, in which a user inputs stroke operations. The candidate display region 742 is a region corresponding to the candidate display region 712 shown in FIGS. 2 and 3, in which candidates are displayed according to input stroke operations.

The stroke history display region 743 is a region in which histories of stroke operations input by the user are displayed. A history of stroke operations can be said to indicate a combination of stroke operations corresponding to a word that the user intends to input. In the example shown in FIG. 8, a stroke operation in the left direction, a stroke operation indicating a dot, a stroke operation in the downward direction, and a stroke operation in the right direction which were input in this order are briefly displayed with arrows and a dot as a history of the stroke operations input by the user. Referring to the history of the stroke operations displayed in the stroke history display region 743, the user can intuitively grasp the stroke operations that he or she has consecutively input to obtain a target word.

Note that, although regions and icons corresponding to the word display region 713, the backspace icon 714, and the menu icon 715 shown in FIGS. 2 and 3 are not provided on the display screen 740 in the example shown in FIG. 8, the display screen 740 may further have regions and icons corresponding to the word display region 713, the backspace icon 714, and the menu icon 715. On the other hand, the word display region 713 shown in FIGS. 2 and 3 may further have a region corresponding to the stroke history display region 743.

As an example, FIG. 8 shows a transition of the display screen of the handwriting input GUI when the user intends to input the word “fine.” In a stage in which input of stroke operations is finished, candidates of the word according to a combination of the stroke operations input by the user are displayed in the candidate display region 742 of the display screen 740 ((a) of the drawing). In the example shown in (a) of FIG. 8, the target word “fine” is not displayed as a high priority word in the candidate display region 742, and “give,” “five,” and “city” which are words corresponding to the combination of the same stroke operations are displayed as candidates.

As in the example shown in FIG. 3, it is also possible to search for “fine” by scroll-displaying the candidates displayed in the candidate display region 742, however, in the present display example, after the user selects a word similar to the target word from the candidates displayed in the candidate display region 742, he or she can change to candidates to be displayed in the candidate display region 742. This operation corresponds to selecting any one from a plurality of candidates displayed in the candidate display region 742 and then, based on the selected candidate, displaying the plurality of candidates in an order of a different priority.

Selection of a similar word is realized through, for example, an operation of moving a finger to trace the word ((b) of the drawing). In the example shown in (b) of FIG. 8, an operation of drawing a finger over “five” among the candidates displayed in the candidate display region 742 is illustrated. Here, when a candidate itself displayed in the candidate display region 742 is desired to be selected as a word to input, a selection operation different from the operation of selecting a similar word, for example, an operation of tapping the word, or the like may be assigned. Accordingly, it is possible to judge whether the user has selected a candidate itself displayed in the candidate display region 742 as a word to input or wants to change candidates displayed in the candidate display region 742 by selecting a similar word.

When a similar word has been selected, the candidates displayed in the candidate display region 742 are changed, and accordingly, candidates similar to the selected word are displayed ((c) of the drawing). This means that the candidates are displayed in an order of a different priority in the candidate display region 742, and in the example shown in (c) of FIG. 8, the order of the candidates to be displayed in the candidate display region 742 is changed to an order of candidates similar to the selected word. As words similar to the selected “five,” “Five,” “fine,” and “fire” are displayed as new candidates in the candidate display region 742 in the example shown in FIG. 8. The user can select the desired word “fine” from the new candidates displayed in the candidate display region 742.

Here, the operation of selecting a word similar to a target word as shown in (b) of the drawing is acquired as operation information by, for example, the operation information acquisition unit 141 of the wristwatch-type terminal 10 shown in FIG. 4. The operation information is transmitted to the portable-type terminal 20 through the communication unit 110, and then, for example, the candidate generation unit 242 generates candidates which have the same combination of the stroke operations and are similar to the selected word. Then, candidate information regarding the generated candidates is transmitted from the portable-type terminal 20 to the wristwatch-type terminal 10, and then the display control unit 142 of the wristwatch-type terminal 10 may change display of the candidate display region 742 based on the candidate information. Note that a criterion of judging a word similar to a selected word generated by the candidate generation unit 242 may be appropriately set, for example, to having the same first letter, or the like.

The example of the display screen of the handwriting input GUI for selecting a word based on similar candidates has been described above with reference to FIG. 8. In the first embodiment, after stroke operations are consecutively input, re-input for changing a priority of candidates to be displayed in the candidate display region 742, for example, selecting a word similar to a target word, or the like may be performed as described above. By changing the priority of candidates to be displayed in the candidate display region 742, the user can find his or her desired word more easily.

Here, two situations in which the user has difficulty finding his or her target word from displayed candidates are considered. One is a case in which, due to an extremely low priority of a target word that is, for example, a special proper noun, or the like, the word is not extracted from the word DB 230 by the candidate generation unit 242, and the other one is a case in which a target word has been extracted from the word DB 230 by the candidate generation unit 242, but the user has difficulty finding the word from displayed candidates due to its low priority in the display order.

The method for narrowing down candidates described in (1-5-1. Designation of letters included in a word) above is a method in which, after stroke operations are consecutively input, letters are designated for each of the consecutively input stroke operations, corresponding to a, so to speak, method for re-inputting a word being input. This can be said to be an effective method when a target word is not extracted from the word DB 230 by the candidate generation unit 242.

On the other hand, the method for narrowing down candidates described in (1-5-2. Selection of a word based on similar candidates) above is a method for finding a target word by using candidates which are already displayed and changing the display priority of the candidates. This can be said to be an effective method when, due to a low priority of a target word in a display order, a user has difficulty finding the word from displayed candidates.

When it is difficult to find a target word from displayed candidates, the candidates are narrowed down by appropriately selecting any of the method described in (1-5-1. Designation of letters included in a word) above and the method described in (1-5-2. Selection of a word based on similar candidates) above according to the situation, and thereby the word can be input with higher efficiency.

[1-6. Modified Examples of the Configuration of the Information Processing System]

In [1-2. Configuration of an information processing system] described above, the case in which the information processing system 1 according to the first embodiment is constituted by the wristwatch-type terminal 10 and the portable-type terminal 20 has been described. The first embodiment, however, is not limited thereto, and the information processing system 1 may be realized with another configuration. Herein, other configuration examples of the information processing system 1 will be described as modified examples of the first embodiment.

(1-6-1. Modified Example in which the Information Processing System is Constituted by One Information Processing Device)

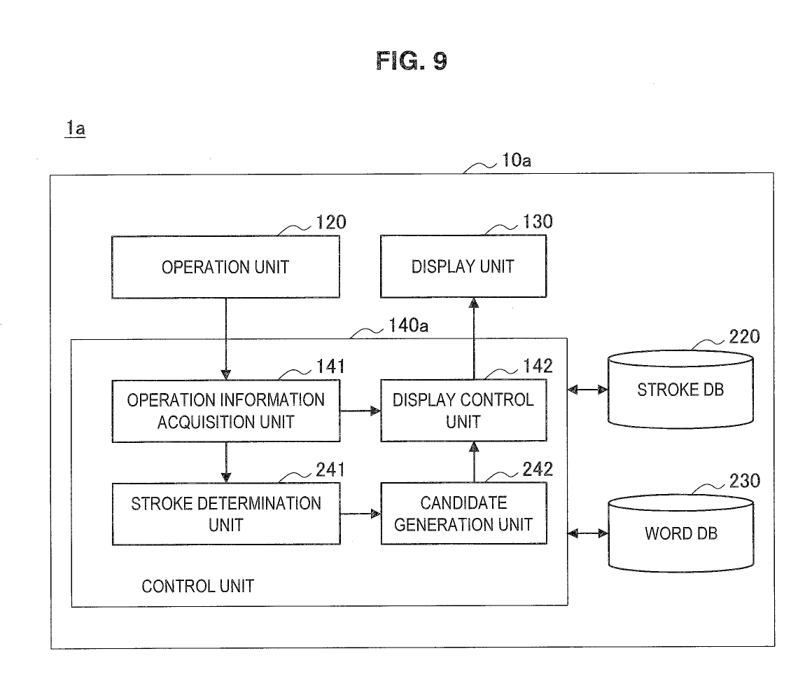

A modified example in which the information processing system according to the first embodiment is constituted by one information processing device will be described with reference to FIG. 9. FIG. 9 is a functional block diagram showing the example of a functional configuration in the modified example in which the information processing system according to the first embodiment is constituted by one information processing device.

Referring to FIG. 9, an information processing system 1a according to the present modified example is provided with a wristwatch-type terminal 10a. Note that the information processing system 1a realizes the same function as the above-described information processing system 1 shown in FIG. 4 with a different configuration of the information processing device.

The wristwatch-type terminal 10a is an example of an information processing device (a so-called wearable terminal) that a user wears and uses. The wristwatch-type terminal 10a can be realized by an information processing device with a hardware configuration to be described in, for example, <4. Hardware configuration> below.

The wristwatch-type terminal 10a is provided with the operation unit 120, the display unit 130, a control unit 140a, the stroke DB 220, and the word DB 230. Here, since each function of the operation unit 120, the display unit 130, the stroke DB 220, and the word DB 230 is the same as the corresponding function of the constituent elements shown in FIG. 4, detailed description thereof will be omitted herein.

The control unit 140a is configured by any of various processors, for example, a CPU, a DSP, and the like to control various processes performed in the wristwatch-type terminal 10a. The control unit 140a has the operation information acquisition unit 141, the display control unit 142, the stroke determination unit 241, and the candidate generation unit 242. The function of the control unit 140a including the functions of the units is realized when, for example, the processor configuring the control unit 140a operates according to a predetermined program.

Here, each function of the operation information acquisition unit 141, the display control unit 142, the stroke determination unit 241, and the candidate generation unit 242 may be the same as that of the constituent elements shown in FIG. 4. As described above, the wristwatch-type terminal 10a of the present modified example possesses the functions of the wristwatch-type terminal 10 and the portable-type terminal 20 together described with reference to FIG. 4, and thereby the information processing system 1a can be constituted by one information processing device.

The modified example in which the information processing system according to the first embodiment is constituted by one information processing device has been described above with reference to FIG. 9. In the present modified example, the series of processes of the handwriting input process are executed only by, for example, the wristwatch-type terminal 10a which is a wearable terminal as described above. A user can perform the handwriting input process wearing only the wearable terminal having better portability, and thus does not have to prepare another information processing device, and therefore user convenience improves. In addition, in a state of the information processing system 1 exemplified in FIG. 4 in which a communication environment between information processing devices is deteriorated for any reason, for example, there is a possibility of the handwriting input process being difficult to execute smoothly. According to the present modified example, since it is not necessary to perform communication between information processing devices, the handwriting input process can be executed regardless of a communication environment.

(1-6-2. Modified Example in which the Information Processing System is Constituted by Three Information Processing Devices)

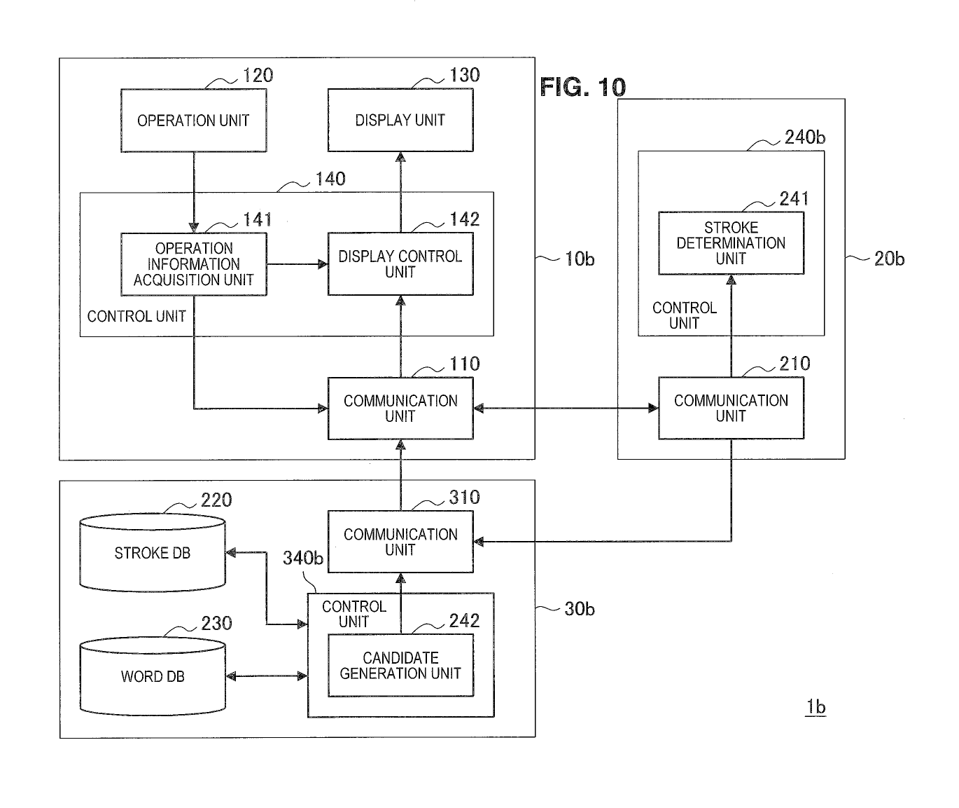

A modified example in which the information processing system according to the first embodiment is constituted by three information processing devices will be described with reference to FIG. 10. FIG. 10 is a functional block diagram showing an example of functional configurations of information processing devices in the modified example in which the information processing system according to the first embodiment is constituted by the three information processing devices.

Referring to FIG. 10, an information processing system 1b according to the present modified example is provided with a wristwatch-type terminal 10b, a portable-type terminal 20b, and a server 30b. Note that the information processing system 1b realizes the same function as the above-described information processing system 1 shown in FIG. 4 with different configurations of the information processing devices.

The wristwatch-type terminal 10b is an example of an information processing device (a so-called wearable terminal) that a user wears and uses. In addition, the portable-type terminal 20b is an example of an information processing device proper for users to carry, for example, a smartphone or a tablet PC. Further, the server 30b is an example of an information processing device that specializes in numerical calculation and information processing, and can be installed on a network (a so-called cloud), for example, the Internet, or the like. The wristwatch-type terminal 10b, the portable-type terminal 20b, and the server 30b can be realized by, for example, information processing devices with the hardware configuration described in <4. Hardware configuration> below. In the present modified example, the handwriting input process is executed when the wristwatch-type terminal 10b, the portable-type terminal 20b, and the server 30b transmit and receive various kinds of information with each other via a network. As a communication scheme used between the wristwatch-type terminal 10b and the portable-type terminal 20b, for example, one based on a communication standard such as Bluetooth, Wi-Fi, or the like can be applied. In addition, as a communication scheme used between the portable-type terminal 20b and the server 30b, any of various communication schemes used in so-called mobile network communication, for example, one based on a communication standard such as Global System for Mobile Communications (GSM; a registered trademark), a third generation (3G) mobile communication system, Long Term Evolution (LTE), Wi-Fi, or the like can be applied.

(Wristwatch-Type Terminal 10b)

The wristwatch-type terminal 10b is provided with the communication unit 110, the operation unit 120, the display unit 130, and the control unit 140. In addition, the control unit 140 has the operation information acquisition unit 141 and the display control unit 142. Since the functional configuration of the wristwatch-type terminal 10b is the same as that of the wristwatch-type terminal 10 shown in FIG. 4, detailed description thereof will be omitted herein.

In the present modified example, however, the communication unit 110 also performs transmission and reception of information with the server 30b in addition to the function that the communication unit 110 of the wristwatch-type terminal 10 shown in FIG. 4 has. In the present modified example, the communication unit 110 transmits operation information including coordinate information of an operating body within a display screen acquired by the operation information acquisition unit 141 to the portable-type terminal 20b. The communication unit 110 can receive candidate information regarding candidates of a letter or a word associated with stroke operations generated based on the operation information from the server 30b. Further, the communication unit 110 may also transmit operation information indicating a word finally selected by a user from displayed candidates acquired by the operation information acquisition unit 141 to the server 30b. The communication unit 110 can receive candidate information regarding word candidates that are anticipated to be input after the word in view of the grammar generated based on the aforementioned operation information indicating the finally selected word from the server 30b.

(Portable-Type Terminal 20b)

The portable-type terminal 20b is provided with the communication unit 210 and a control unit 240b.

Here, the function of the communication unit 210 may be substantially the same as the function that the communication unit 210 of the portable-type terminal 20 shown in FIG. 4 has. In the present modified example, however, the communication unit 210 also performs transmission and reception of information with the server 30b, in addition to the function that the communication unit 210 of the portable-type terminal 20 shown in FIG. 4 has. In the present modified example, the communication unit 210 receives operation information including coordinate information of an operating body within a display screen from the wristwatch-type terminal 10b. Further, the communication unit 210 can transmit information regarding a determination result of a stroke operation determined based on the operation information by the stroke determination unit 241 of the control unit 240b to be described later to the server 30b.

The control unit 240b is constituted by, for example, any of various processors such as a CPU, a DSP, or the like, and controls various processes performed in the portable-type terminal 20b. The control unit 240b has the stroke determination unit 241. A function of the control unit 240b including the function is realized when, for example, the processor constituting the control unit 240b operates according to a predetermined program.

Here, since the function of the stroke determination unit 241 is the same as that of the constituent element shown in FIG. 4, detailed description thereof will be omitted herein. The stroke determination unit 241 determines input stroke operations based on operation information acquired by the operation information acquisition unit 141 of the wristwatch-type terminal 10b. A result of the determination is transmitted to the server 30b through the communication unit 210. As described, candidates are not generated in the portable-type terminal 20b in the present modified example. Thus, a load of signal processing on the portable-type terminal 20b is reduced.

(Server 30b)

The server 30b is provided with a communication unit 310, the stroke DB 220, the word DB 230, and a control unit 340b. Here, since each function of the stroke DB 220 and the word DB 230 is the same as that of the constituent elements shown in FIG. 4, detailed description thereof will be omitted.

The communication unit 310 is a communication interface for connecting the server 30b to another external device so that the devices can communicate with each other. The server 30b can transmit and receive various kinds of information with the wristwatch-type terminal 10b and the portable-type terminal 20b through the communication unit 310. In the present modified example, the communication unit 310 can receive information regarding determination results of stroke operations by the stroke determination unit 241 from the portable-type terminal 20b. The communication unit 310 can transmit candidate information regarding candidates of a letter or a word associated with stroke operations generated based on the determination results by the candidate generation unit 242 of the control unit 340b to be described later to the wristwatch-type terminal 10b. In addition, the communication unit 310 may receive operation information indicating a word finally selected by the user from displayed candidates acquired by the operation information acquisition unit 141 from the wristwatch-type terminal 10b. The communication unit 310 can transmit candidate information regarding word candidates that are anticipated to follow the selected word in view of the grammar generated based on the operation information indicating the finally selected word by the candidate generation unit 242 of the control unit 340b to be described later to the wristwatch-type terminal 10b.

The control unit 340b is constituted by, for example, any of various processors such as a CPU, a DSP, or the like, and controls various processes performed in the server 30b. The control unit 340b has the candidate generation unit 242. A function of the control unit 340b including the function is realized when, for example, the processor constituting the control unit 340b operates according to a predetermined program.

Here, since the function of the candidate generation unit 242 is the same as that of the constituent element shown in FIG. 4, detailed description thereof will be omitted herein. The candidate generation unit 242 generates candidates of a letter or a word corresponding to a stroke operation based on a determination result of the stroke operation by the stroke determination unit 241. In addition, based on operation information indicating a word finally selected by the user from displayed candidates, the candidate generation unit 242 may generate word candidates that are anticipated to follow the selected word in view of grammar. Information regarding the generated letter or word candidates is transmitted to the wristwatch-type terminal 10b through the communication unit 310. In the wristwatch-type terminal 10b, the display control unit 142 causes letter or word candidates to be displayed on the display screen of the handwriting input GUI based on the candidate information.

The modified example in which the information processing system according to the first embodiment is constituted by three information processing devices has been described above with reference to FIG. 10.

Here, in the handwriting input process, as an amount of information of the stroke DB 220 and the word DB 230 is larger, the number of candidates generated by the candidate generation unit 242 increases, and thus a chance of a candidate of a letter or a word that the user wants being generated is considered to increase accordingly. However, as the amount of information of the stroke DB 220 and the word DB 230 is larger, a storage device constituting the stroke DB 220 and the word DB 230 can grow in size, and a load of signal processing in a candidate generation process can increase as well. For the wristwatch-type terminal 10b and the portable-type terminal 20b in which portability is a consideration, a growing size of a housing and a high load of signal processing are not desirable.

On the other hand, in the present modified example, a candidate generation process by the candidate generation unit 242 is performed by the server 30b described above. Since the server 30b is a device installed on, for example, a network, even if it has bigger hardware, it is not a burden for the user. In addition, since the server 30b is a device that is, for example, configured to specialize in signal processing, it can perform signal processing at a higher speed. Thus, according to the present modified example, even if the amount of information of the stroke DB 220 and the word DB 230 increases, the handwriting input process can be smoothly performed without causing a burden to the user.

### 2. Second Embodiment

Next, the second embodiment of the present disclosure will be described. As described above, each letter is association with a stroke operation, candidates of a corresponding letter or word are displayed according to input stroke operations or a combination of stroke operations, and thereby a letter or a word is input in the first embodiment. In this manner, a letter is recognized based on a stroke operation in the first embodiment. In the second embodiment, in addition to recognition of a letter based on a stroke operation of the first embodiment, character recognition is performed based on a handwritten character input operation that is an operation of drawing an entire shape of a letter with an operating body.

As described above, it is hard to say that inputting all characters or words of a sentence into, for example, a small-sized terminal through a handwritten character input operation is favorable in view of operability. However, there are cases in which inputting some characters more directly through a handwritten character input operation allows a handwriting input process to be executed more smoothly, for example, depending on content of a word to be input. In the second embodiment, a handwriting input process is executed with higher accuracy and a higher degree of freedom by using both of input of a letter or a word through a stroke operation and input of a letter or a word through a handwritten character input operation, as needed.

Note that, in description of the second embodiment below, detailed description of overlapping matters with the first embodiment will be omitted, and differences from the first embodiment will be mainly described. In addition, as an example of the second embodiment, a case in which a handwritten character input operation and a stroke operation are input together via a touch panel as a motion of an operating body will be described hereinbelow. The second embodiment, however, is not limited thereto. For example, the handwritten character input operation may be input as a motion of the operating body via the touch panel, and the stroke operation may be input via an input interface (for example, a device such as a joystick that can input directions, or a sensor device that can detect motions (gestures) of a user) other than the touch panel.

[2-1. Configuration of an Information Processing System]

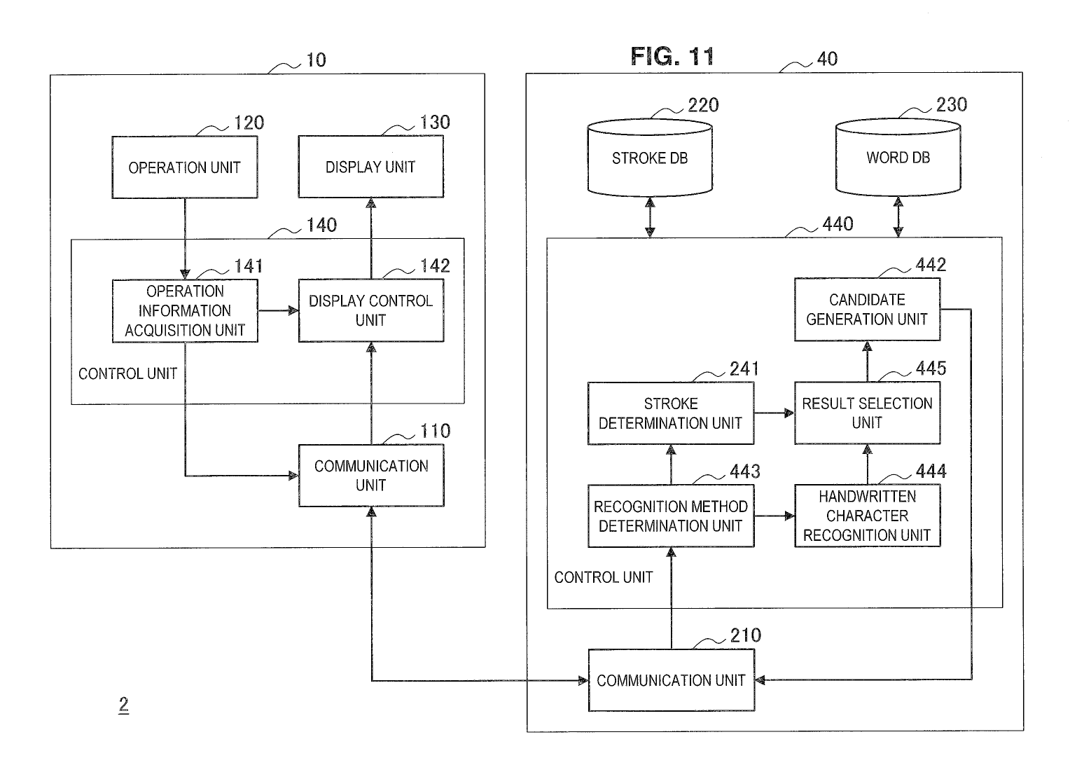

A configuration example of an information processing system for realizing a handwriting input process according to the second embodiment will be described with reference to FIG. 11. FIG. 11 is a functional block diagram showing an example of a functional configuration of the information processing system according to the second embodiment of the present disclosure.

FIG. 11 illustrates, as an example of the second embodiment, the functional configuration of the information processing system when the handwriting input process is executed by the information processing system constituted by a plurality of information processing devices. The second embodiment, however, is not limited thereto, and the handwriting input process according to the second embodiment may be executed by a single information processing device, or executed in cooperation with a plurality of information processing devices. A case in which the information processing system is realized with a different configuration will be described in [2-4. Modified examples of the configuration of the information processing system] in detail below.

Referring to FIG. 11, the information processing system 2 according to the second embodiment is provided with the wristwatch-type terminal 10 and a portable-type terminal 40. Here, since a functional configuration of the wristwatch-type terminal 10 is the same as that of the wristwatch-type terminal 10 according to the first embodiment shown in FIG. 4, detailed description thereof will be omitted.

The portable-type terminal 40 is an example of an information processing device proper for user to carry, which is, for example, a smartphone or a tablet PC. The portable-type terminal 40 can be realized by, for example, an information processing device with the hardware configuration that will be described in <4. Hardware configuration>. In the second embodiment, the handwriting input process is executed as the wristwatch-type terminal 10 and the portable-type terminal 40 transmit and receive various kinds of information with each other via a network. As a communication scheme between the wristwatch-type terminal 10 and the portable-type terminal 40, for example, one based on a communication standard such as Bluetooth or Wi-Fi can be applied.

The portable-type terminal 40 is provided with the communication unit 210, the stroke DB 220, the word DB 230, a control unit 440, and a handwritten character DB 450. Here, since each function of the communication unit 210, the stroke DB 220, and the word DB 230 is the same as that of the constituent elements shown in FIG. 4, detailed description thereof will be omitted herein.

The control unit 440 is constituted by, for example, any of various processors such as a CPU, a DSP, or the like, and controls various processes performed in the portable-type terminal 40. The control unit 440 has a recognition method determination unit 443, a stroke determination unit 241, a handwritten character recognition unit 444, a result selection unit 445, and a candidate generation unit 442. A function of the control unit 440 including the functions is realized when, for example, the processor constituting the control unit 440 operates according to a predetermined program.

The recognition method determination unit 443 determines whether an operation input with an operating body is a stroke operation or a handwritten character input operation based on operation information including coordinate information of the operating body acquired by the operation information acquisition unit 141 of the wristwatch-type terminal 10, and then determines whether recognition of a letter based on the stroke operation should be performed or recognition of a letter based on the handwritten character input operation should be performed.

A method of determining operation input by the recognition method determination unit 443 will be described. For example, the recognition method determination unit 443 may determine operation input based on a size of a trace drawn by the operating body during the input which can be computed from the coordinate information. To be specific, the recognition method determination unit 443 can determine operation input by comparing a size of an input region on a display screen of a handwriting input GUI to a size of a trace drawn by the operating body during the input. For example, since a stroke operation is an operation of drawing a dot or an operation of drawing a line extending in one direction, the size of the trace of the operating body can be quite small. Thus, when the size of the trace drawn by the operating body during the input accounts for a predetermined ratio or higher to the size of the input region on the display screen of the handwriting input GUI, the operation performed by the user can be considered to have a high possibility of being the handwritten character input operation rather than a stroke operation. Here, the size of the trace drawn by the operating body may be, for example, the length of the trace. In addition, the size of the input region on the display screen of the handwriting input GUI may be, for example, the length of one side of the input region.

Thus, when the size of the trace of the operating body accounts for a predetermined ratio or higher to the size of the input region, the recognition method determination unit 443 determines that the operation input with the operating body is the handwritten character input operation, and thereby judges that character recognition should be performed based on the handwritten character input operation. In addition, when the size of the trace of the operating body accounts for less than a predetermined ratio to the size of the input region, the recognition method determination unit 443 determines that the operation input with the operating body is the stroke operation, and thereby judges that character recognition should be performed based on the stroke operation.

Furthermore, the recognition method determination unit 443 may perform determination of operation input based on, for example, a shape of a trace drawn by the operating body during the input that can be computed from coordinate information. A trace of the operating body in a stroke operation is considered, for example, not to have a substantial flexure having a high curvature. Thus, when a trace drawn by the operating body during input has a flexure having a curvature of a predetermined value or higher, there is a high possibility of the operation performed by the user being the handwritten character input operation rather than a stroke operation. Therefore, when a trace of the operating body has a flexure having a curvature of a predetermined value or higher, the recognition method determination unit 443 determines that operation input with the operating body is the handwritten character input operation, and thereby judges that character recognition should be performed based on the handwritten character input operation. When a trace of the operating body has a flexure having a curvature less than the predetermined value, the recognition method determination unit determines that the operation input with the operating body is a stroke operation, and thereby judges that character recognition should be performed based on the stroke operation.

Note that a specific method of the recognition method determination unit 443 for determining operation input based on coordinate information of the operating body during input is not limited to that example. The recognition method determination unit 443 may determine whether operation input with the operating body is a stroke operation or a handwritten character input operation based on coordinate information of the operating body using another method. When, for example, a handwritten character input operation is input as a motion of the operating body via the touch panel, and a stroke operation is input via an input interface (for example, a device such as a joystick that can input directions, or a sensor device that can detect motions (gestures) of a user) other than the touch panel, the recognition method determination unit 443 may determine whether operation input is a stroke operation or a handwritten character input operation according to the type of the input interface with which the operation input is performed.

When an input operation is determined to be a stroke operation, the recognition method determination unit 443 provides operation information including input coordinate information of the operating body to the stroke determination unit 241, and instructs to determine the stroke operation based on the operation information. In addition, when the input operation is determined to be a handwritten character input operation, the recognition method determination unit 443 provides the input coordinate information of the operating body to the handwritten character recognition unit 444, and instructs to perform recognition of the input handwritten character based on the coordinate information.

Since the function of the stroke determination unit 241 is the same as that of the constituent element shown in FIG. 4, detailed description thereof will be omitted herein. The stroke determination unit 241 determines input stroke operations based on operation information including coordinate information of the operating body. The stroke determination unit 241 provides information of results of determination of the stroke operations to the result selection unit 445.

The handwritten character recognition unit 444 recognizes characters input in handwriting based on coordinate information of the operating body in a handwritten character input operation. For example, the handwritten character recognition unit 444 can recognize a letter corresponding to a handwritten character input operation by matching a trace of the operating body input in the handwritten character input operation with a template of a DB in which a variety of forms which correspond to letters are stored. However, a method of the handwritten character recognition unit 444 for recognizing a letter based on the handwritten character input operation is not limited thereto, and any of various methods used in general handwritten character recognition technologies may be used. The handwritten character recognition unit 444 can have various functions that a general handwritten character recognition engine has. The handwritten character recognition unit 444 provides information regarding a recognition result of a letter to the result selection unit 445.

When character recognition is performed based on the handwritten character input operation by the handwritten character recognition unit 444, the result selection unit 445 determines accuracy of the recognition result. Based on the determination result, the result selection unit 445 can select whether candidate generation should be performed using the determination result of the stroke operation, or candidate generation should be performed using the recognition result of the letter based on the handwritten character input operation.

When the handwritten character recognition unit 444 recognizes a handwritten letter, for example, a trace of the operating body input in the handwritten character input operation is matched with a template of the DB as described above. Here, a degree of similarity between the trace of the operating body and the template of the DB can be said to be an index indicating accuracy of a recognition result of the letter by the handwritten character recognition unit 444. In this manner, for recognition of the handwritten letter by the handwritten character recognition unit 444, the accuracy of the recognition result can be computed. The result selection unit 445 can acquire information regarding the accuracy from the handwritten character recognition unit 444.

The result selection unit 445, for example, compares the accuracy of the recognition result to a predetermined threshold value. When the accuracy of the recognition result is equal to or higher than the threshold value, reliability of the recognition result of the letter by the handwritten character recognition unit 444 can be said to be sufficiently high. Thus, when the accuracy of the recognition result is equal to or higher than the threshold value, the result selection unit 445 selects candidate generation to be performed using the recognition result of the letter based on the handwritten character input operation, then transmits information regarding the recognition result to the candidate generation unit 442, and issues an instruction to the candidate generation unit 442 to generate candidates of the letter based on the recognition result.

On the other hand, when the accuracy is lower than the threshold value, there is a possibility of the determination result of the operation input by the recognition method determination unit 443 being incorrect. Thus, when the accuracy is lower than the threshold value, the result selection unit 445 selects candidate generation using the determination result of the stroke operation, and issues an instruction to the stroke determination unit 241 to determine the stroke operation again based on the operation information. Then, the result selection unit transmits information regarding the determination result of the stroke operation by the stroke determination unit 241 to the candidate generation unit 442, and issues an instruction to the candidate generation unit 442 to generate candidates of the letter based on the determination result.

In this manner, in the second embodiment, accuracy of a recognition result of a letter by the handwritten character recognition unit 444 is evaluated by the result selection unit 445, and when the accuracy is low, candidate generation is performed based on a determination result of a stroke operation that is another operation input. Accordingly, a letter can be input using a result with higher reliability between the determination result of the stroke operation and the recognition result of the letter based on the handwritten character input operation, and thereby highly accurate letter input is realized.

The candidate generation unit 442 has a function of generating candidates of a character corresponding to a handwritten character input operation based on a recognition result of the input character in the handwritten character input operation, in addition to the function of the candidate generation unit 242 according to the first embodiment shown in FIG. 4. In other words, based on an instruction from the result selection unit 445, the candidate generation unit 442 can generate candidates of the character corresponding to an input stroke operation and/or handwritten character input operation using either of a determination result of the stroke operation and a recognition result of the character based on the handwritten character input operation. When a plurality of stroke operations and/or handwritten character input operations are consecutively performed, the candidate generation unit 442 generates candidates of a word corresponding to a combination of the input stroke operations and/or handwritten character input operations based on a plurality of instructions consecutively given from the result selection unit 445.

Candidate information regarding candidates of a letter or a word generated by the candidate generation unit 442 is transmitted to the wristwatch-type terminal 10 through the communication unit 210. In the wristwatch-type terminal 10, the display control unit 142 causes the candidates of the letter or the word corresponding to the input stroke operations and/or handwritten character input operations to be displayed on the display screen of the handwriting input GUI based on the candidate information.

The configuration example of the information processing system 2 for realizing the handwriting input process according to the second embodiment has been described above with reference to FIG. 11. As described above, by using both of character recognition based on a stroke operation and character recognition based on a handwritten character input operation in the second embodiment, it can be said that so-called character recognition engines of different types are used together. Thus, according to accuracy in character recognition, using a character recognition engine that is considered to have higher accuracy in character recognition can be selected. Therefore, a handwriting input process that has high accuracy in character recognition is realized.

Note that, in the above embodiment, although the result selection unit 445 determines only accuracy of a recognition result of a character by the handwritten character recognition unit 444, the second embodiment is not limited thereto. The result selection unit 445 may determine accuracy of a determination result of a stroke operation by the stroke determination unit 241, along with or instead of determination of the accuracy of the recognition result of the character by the handwritten character recognition unit 444. A direction of a stroke operation stored in the stroke DB 220 is unlikely to coincide exactly with a direction actually input in a stroke operation (for example, a direction that a trace of the operating body indicates), and there can be some degree of deviation amount between the directions. The deviation amount can be said to be an index indicating accuracy of a determination result of a stroke operation by the stroke determination unit 241. The result selection unit 445 compares the accuracy of the determination result of the stroke operation by the stroke determination unit 241 to a predetermined threshold value, and when the accuracy is equal to or higher than the threshold value, candidate generation using the determination result of the stroke operation may be selected, and when the accuracy is lower than the threshold value, candidate generation using a recognition result of the character based on the handwritten character input operation may be selected. Accordingly, character recognition can be performed using a result with higher reliability between the determination result of the stroke operation and the recognition result of the character based on the handwritten character input operation, and thus a more accurate handwriting input process can be realized.

[2-2. Process Procedure of an Information Processing Method]

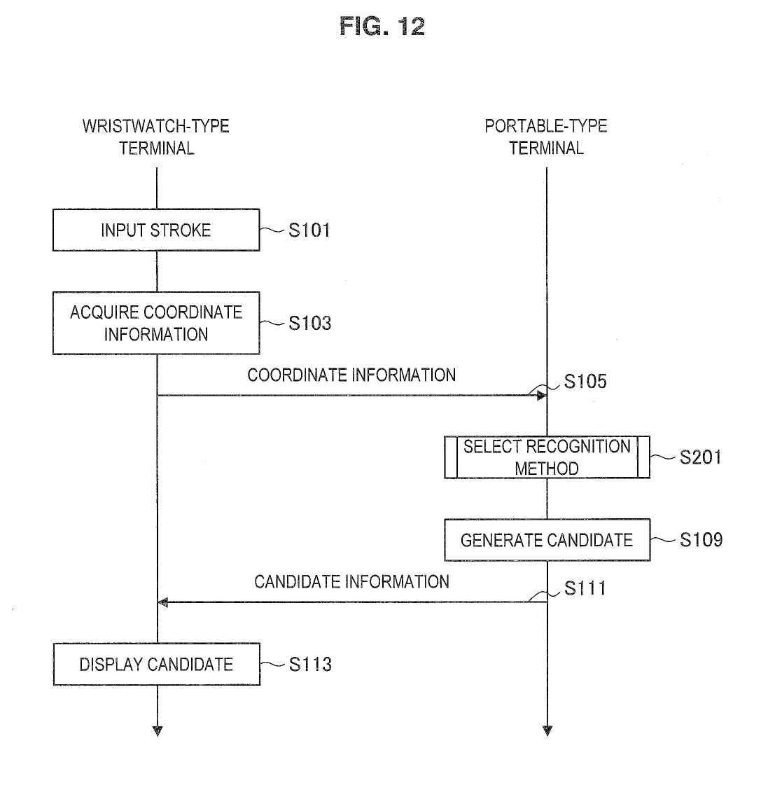

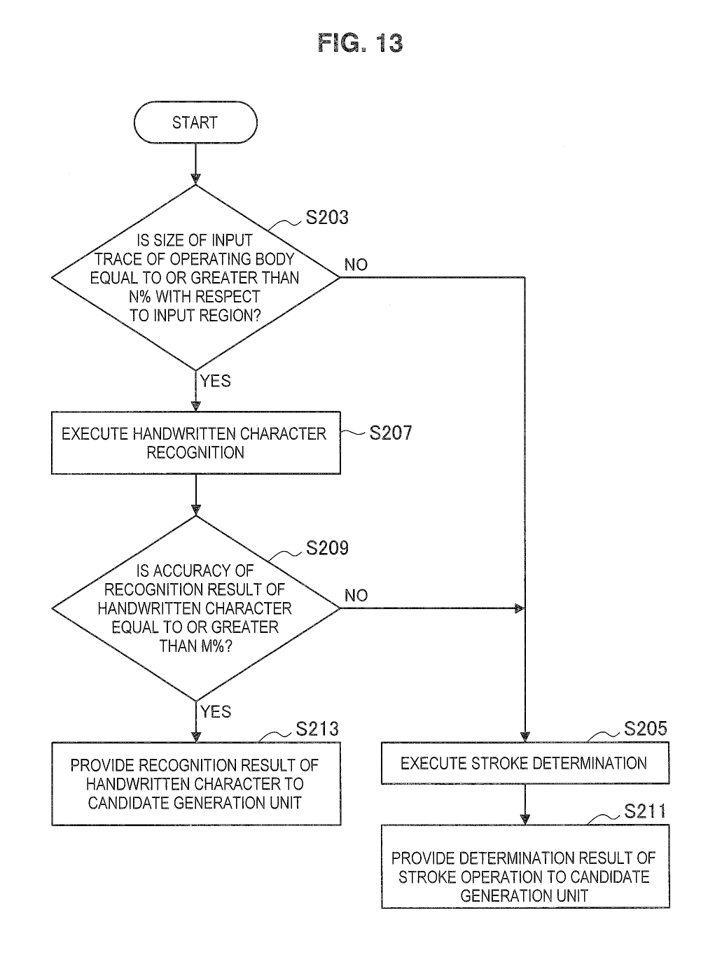

Next, a process procedure of an information processing method according to the second embodiment will be described with reference to FIGS. 12 and 13. FIG. 12 is a flowchart showing an example of the process procedure of the information processing method according to the second embodiment. FIG. 13 is a flowchart showing an example of a process procedure of a selection process of a recognition method shown in FIG. 12. The series of processes performed in the information processing method correspond to the series of processes of the handwriting input process according to the second embodiment, and can be realized with, for example, the functional configuration of the information processing system 2 shown in FIG. 11.

Note that the process procedure of the information processing method according to the second embodiment corresponds to the process procedure of the information processing method according to the first embodiment shown in FIG. 5 in which the process shown in Step S107 is changed to a process of selecting a recognition method to be described later. In the second embodiment, the processes shown in Step S101 to Step S105 and the processes shown in Step S109 to Step S113 may be the same as in the first embodiment. Thus, in description of the information processing method according to the second embodiment below, the process of selecting a recognition method, which is a difference from the first embodiment, will be mainly described.

Referring to FIG. 12, in the information processing method according to the second embodiment, when operation information including coordinate information is transmitted from the wristwatch-type terminal 10 to the portable-type terminal 40 in Step S105, the process of selecting a recognition method is performed in the portable-type terminal 40 (Step S201). In Step S201, whether character recognition based on a stroke operation should be performed or character recognition based on a handwritten character input operation should be performed is selected according to operation input of a user.

The process of selecting a recognition method in Step S201 will be described in detail with reference to FIG. 13. Referring to FIG. 13, in the process of selecting a recognition method, it is first determined whether or not a size of an input trace of the operating body is equal to or greater than N % (N is an arbitrary positive value smaller than 100) with respect to the input region based on the coordinate information (Step S203). Note that the process shown in Step S203 is an example of the process performed by the above-described recognition method determination unit 443 to determine whether character recognition based on a stroke operation should be performed or character recognition based on a handwritten character input operation should be performed. In the example shown in FIG. 13, the size of the trace of the operating body is compared to the size of the input region, however, a recognition method of a character may be determined using another method in Step S203. For example, a character recognition method may be determined based on a shape of the trace of the operating body as described above in Step S203.

When the size of the trace of the operating body is smaller than N % with respect to the input region, for example, there is a high possibility of the operation input by the user being a stroke operation. Thus, when the size of the trace of the operating body is determined to be smaller than N % with respect to the input region in Step S203, the process proceeds to Step S205, and it is determined to be an input stroke operation based on the coordinate information. The process shown in Step S205 may be, to be specific, a process of the stroke determination unit 241 of the portable-type terminal 40 determining content of the input stroke operation based on the operation information including the coordinate information of the operating body acquired by the operation information acquisition unit 141 of the wristwatch-type terminal 10. When the determination of the stroke operation has been made in Step S205, the determination result is provided to the candidate generation unit 442 (Step S211).

On the other hand, in Step S203, when the size of the trace of the operating body is equal to or higher than N % with respect to the input region, there is a high possibility of the operation input by the user being a handwritten character input operation. Thus, when the size of the trace of the operating body is determined to be equal to or higher than N % with respect to the input region in Step S203, the process proceeds to Step S207, and the handwritten character input in the handwritten character input operation is recognized based on the coordinate information. The process shown in Step S207 may be, to be specific, a process performed by the handwritten character recognition unit 444 of the portable-type terminal 40 to recognize the character input in the handwritten character input operation based on the coordinate information of the operating body acquired by the operation information acquisition unit 141 of the wristwatch-type terminal 10.

When the process shown in Step S207 has been performed, it is next determined whether accuracy of a recognition result of the handwritten character performed in Step S207 is equal to or higher than M % (M is an arbitrary positive value smaller than 100) (Step S209). The process shown in Step S209 may be, to be specific, a process of the result selection unit 445 of the portable-type terminal 40 determining the accuracy of the recognition result of the handwritten character performed in Step S207, and then based on the accuracy, selecting whether candidate generation using the determination result of the stroke operation should be performed or candidate generation using the recognition result of the character based on the handwritten character input operation should be performed.

When the accuracy of the recognition result of the handwritten character is determined to be smaller than M % in Step S209, reliability of the recognition result of the handwritten character is considered to be low, and thus the result selection unit 445 selects candidate generation to be performed using the determination result of the stroke operation. Thus, the process proceeds to Step S205, and determination of the stroke operation is performed based on the operation information including the coordinate information of the operating body. When the determination of the stroke operation has been performed in Step S205, the determination result is provided to the candidate generation unit 442 (Step S211).

On the other hand, when the accuracy of the recognition result of the handwritten character is determined to be equal to or higher than M % in Step S209, reliability of the recognition result of the handwritten character is considered to be high, and thus the result selection unit 445 selects candidate generation to be performed using the recognition result of the character based on the handwritten character input operation. Thus, the process proceeds to Step S213, and the recognition result of the handwritten character performed in Step S207 is provided to the candidate generation unit 442.

The process of selecting a recognition method shown in Step S201 has been described above in detail with reference to FIG. 13. In the information processing method according to the second embodiment, with reception of the result of the process of selecting a recognition method shown in Step S201 as shown in FIG. 12, for example, the candidate generation unit 442 generates candidates of the character or word (Step S109). Since the processes from Step S109 are the same as in the first embodiment, detailed description thereof will be omitted.

The process procedure of the information processing method according to the second embodiment has been described hereinabove with reference to FIGS. 12 and 13. Here, FIGS. 12 and 13 show the process procedure when the information processing method is realized with the configuration of the information processing system 2 shown in FIG. 11 as an example of the process procedure of the information processing method according to the second embodiment. A process procedure of the information processing method according to the second embodiment is not limited to the example shown in FIGS. 12 and 13, and a terminal that performs each of the processes shown in Step S101 to Step S113 may be appropriately changed according to the configuration of the information processing system 2.

[2-3. Candidate Display Example (an Operation for Narrowing Down Candidates)]

Next, a candidate display example in the handwriting input GUI according to the second embodiment will be described. Also in the second embodiment, the same display as display of candidates in the first embodiment described with reference to, for example, FIGS. 1, 2, and 6 may be performed in the handwriting input GUI.

Here, as described in [1-5. Operation for narrowing down candidates] above, when the user has difficulty finding a target word from candidates displayed as a result of a stroke operation performed in the first embodiment, he or she can perform an operation for narrowing down the candidates. Also in the second embodiment, when it is difficult to find a target word, such an operation for narrowing down candidates may be performed in the handwriting input GUI as well. However, in the second embodiment, since candidate generation based on a stroke operation and candidate generation based on a handwritten character input operation can be performed, candidates can be narrowed down using a different method from the first embodiment.

Here, as also described in [1-5. Operation for narrowing down candidates] above, as a situation in which a user has difficulty finding a target word from displayed candidates of example, the case in which, due to an extremely low priority of the target word that is, for example, a special proper noun, or the like, the word is not extracted from the word DB 230 by the candidate generation unit 242 is considered. In this case, in the first embodiment, candidates are narrowed down by designating letters included in the word one by one based on stroke operations. In a more direct manner, however, re-inputting the letters included in the word through a handwritten character input operation is more likely to easily find the target word. The handwriting input process according to the second embodiment can be preferably applied to such a case in which, due to an extremely low priority of the target word, the word is not extracted from the word DB 230 by the candidate generation unit 242. Herein, as an example of the handwriting input GUI of the second embodiment, a display example of the handwriting input GUI when candidates are narrowed down through a handwritten character input operation will be described.

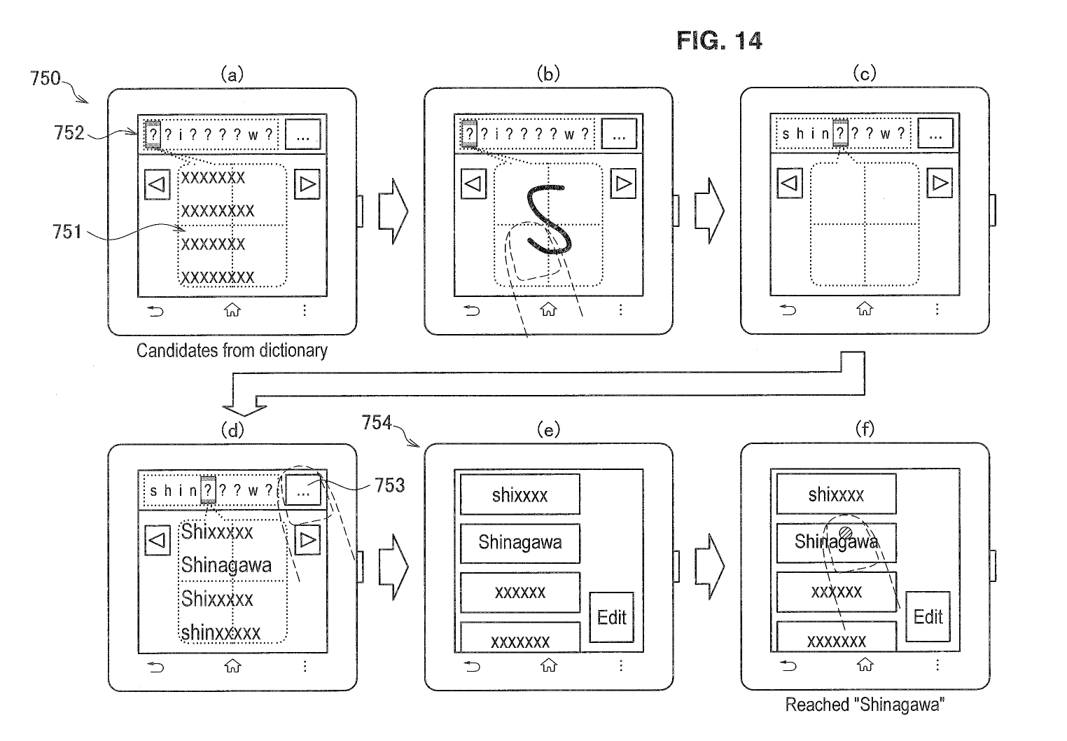

A display example of the handwriting input GUI when candidates are narrowed down though a handwritten character input operation will be described with reference to FIG. 14. FIG. 14 is a diagram showing the display example of the handwriting input GUI when candidates are narrowed down through a handwritten character input operation. As an example, transitions of a display screen of the handwriting input GUI when a user intends to narrow down candidates to input the word “Shinagawa” are shown in FIG. 14. Note that a series of processes to be described with reference to FIG. 14 can be realized with, for example, the functional configuration of the information processing system 2 shown in FIG. 11. Display of the handwriting input GUI shown in FIG. 14 can be controlled by, for example, the display control unit 142 of the wristwatch-type terminal 10 shown in FIG. 11, and thereby performed on the display unit 130.

Now, a user is assumed to want to input the word “Shinagawa” and to perform, in the input region 711 of the display screen 710 of the handwriting input GUI as shown in, for example, FIGS. 2 and 3, a series of stroke operations corresponding to “Shinagawa” (a stroke operation in the left direction, a stroke operation in the downward direction, a stroke operation indicating a dot, a stroke operation in the downward direction, a stroke operation in the left direction, a stroke operation in the left direction, a stroke operation in the left direction, a stroke operation in the downward direction, and a stroke operation in the left direction). According to the stroke operations, candidates of the input stroke operations are displayed in the candidate display region 712 of the display screen 710.

In the second embodiment, when the target word “Shinagawa” is not found from the candidates displayed in the candidate display region 712, a display screen of the handwriting input GUI for narrowing down the candidates can be displayed as the user performs a predetermined switching operation, for example, selecting a screen switching icon.

(a) of FIG. 14 shows a display screen 750 of the handwriting input GUI for narrowing down the candidates immediately after the display is switched as described above. Referring to (a) of FIG. 14, the display screen 750 of the handwriting input GUI for narrowing down the candidates has an input region 751 and a word display region 752. In addition, the candidates of the word may be displayed palely on the background of the input region 751 of the display screen 750.

The input region 751 is a region that corresponds to the input region 711 shown in FIGS. 2 and 3, in which the user inputs stroke operations. In the second embodiment, however, the user may perform handwritten character input operations in the input region 751.

The word display region 752 is a region corresponding to the word display region 713 shown in FIGS. 2 and 3, in which a word finally selected by a user among the displayed candidates is displayed. Since a final word has not yet been selected on the display screen 750 in the example shown in FIG. 14(a), the symbols of “?” are displayed in the portion corresponding to input letters of the word.

For example, the user selects a letter that he or she wants to re-input through a handwritten character input operation from a sequence of letters displayed in the word display region 752 indicating the word. In the example shown in (a) of FIG. 14, the symbol of “?” that indicates the first letter is selected from the sequence of the letters displayed in the word display region 752 indicating the word.

In this state, the user re-inputs the letter corresponding to the first letter in the input region 751 through the handwritten character input operation ((b) of the drawing). In the example shown in (b) of FIG. 14, an “s” is input in the handwritten character input operation as the letter corresponding to the first letter. With respect to the input handwritten character input operation, a character recognition process is performed by, for example, the handwritten character recognition unit 444 of the information processing system 2 shown in FIG. 11, and an “s” is generated by the candidate generation unit 442 based on a result of the recognition as a candidate of the letter corresponding to the handwritten character input operation. The generated candidate “s” is reflected in display of the word display region 752. In this manner, in portions corresponding to letters for which re-input is performed through the handwritten character input operation by the user in the sequence of the letters displayed in the word display region 752 indicating the word, the re-input letters are displayed.

By selecting letters included in the word one by one, the user can sequentially perform re-input in the handwritten character input operation. (c) of FIG. 14 shows the state in which letters up to the “n” serving as the fourth letter have been re-input.

Here, although not illustrated in (b) and (c) of FIG. 14 for the sake of simplification, candidates of the word can be displayed palely on the background of the input region 751 of the display screen 750 as shown in (a) of FIG. 14. The candidates of the word displayed as the background may be updated to candidates corresponding to the sequence of letters corresponding to the input stroke operations and re-input handwritten character input operations by the candidate generation unit 442 each time, for example, the user re-inputs a letter.

For example, when letters up to the “n” serving as the fourth letter have been re-input, the target word “Shinagawa” is assumed to be displayed among the candidates of the word on the background ((d) of the drawing). At this time, the user can stop re-inputting through the handwritten character input operation, and switch the display of the display screen 750 into a display state in which the candidates are displayed in the form of a list, without displaying the input region 751. This display state corresponds to the “second display state” described in [1-4. Candidate display example] above with reference to FIG. 6, and in the display state, a candidate display screen on which the candidates are displayed in the form of a list is displayed. For example, a transition icon 753 for transitioning the display screen is displayed within the display screen 750 as shown in (d) of FIG. 14. Upon finding the target word among the candidates of the word displayed on the background, the user selects the transition icon 753.

When the transition icon 753 has been selected, the display screen 750 transitions to a candidate display screen 754 ((e) of the drawing). Here, the candidate display screen 754 may be a display screen with the same function as the candidate display screen 726 shown in FIG. 6. As shown in (e) of FIG. 14, the candidates of the word corresponding to a combination of the input stroke operations and handwritten character input operations are displayed in the form of a list on the candidate display screen 754. The candidates displayed on the candidate display screen 754 can be scroll-displayed according to an operation input by the user. Upon finding the target word “Shinagawa” from the scroll-displayed candidates, the user can select the word “Shinagawa” ((f) of the drawing). When the word has been selected, display of the handwriting input GUI transitions to the initial display screen, for example, the display screen 710 shown in FIG. 2, and then “Shinagawa” is displayed in the word display region 713 of the display screen 710. On the display screen 710, the user can continuously input a letter or a word following “Shinagawa” through a stroke operation or a handwritten character input operation.

The display example of the handwriting input GUI when candidates are narrowed down through the handwritten character input operation has been described above with reference to FIG. 14. In the second embodiment, after stroke operations are consecutively input, the operation of re-inputting letters included in a word through handwritten character input operations may be performed for candidates of the word corresponding to a combination of the stroke operations as described above. By re-inputting the letters included in the word using the handwritten character input operations as above, it is possible to more directly input even a word that is not present in the word DB, for example, a special proper noun, or the like.

Note that the series of processes described with reference to FIG. 14 can be referred to as a letter re-input process because it is a process in which, after stroke operations are consecutively input, letters included in a word corresponding to a combination of the stroke operations are designated again as in the process described in (1-5-1. Designation of letters included in a word) above. The display screen 750 shown in FIG. 14 is a display screen relating to a re-input mode for re-inputting letters, having a different function from, for example, the display screen relating to the normal input mode as shown in FIGS. 2 and 3. In the same manner as in the first embodiment described above, a word can be input appropriately switching the normal input mode and the re-input mode as needed also in the second embodiment. In the second embodiment, however, since it is possible to more directly re-input a letter through a handwritten character input operation, the user can reach his or her desired word more easily, and thereby user convenience is further enhanced.

[2-4. Modified Examples of the Configuration of the Information Processing System]

In [2-1. Configuration of an information processing system] described above, the case in which the information processing system 2 according to the second embodiment is constituted by the wristwatch-type terminal 10 and the portable-type terminal 40 has been described. The second embodiment, however, is not limited thereto, and the information processing system 2 may be realized with another configuration. Herein, other configuration examples of the information processing system 2 will be described as modified examples of the second embodiment.

(2-4-1. Modified Example in which the Information Processing System is Constituted by One Information Processing Device)

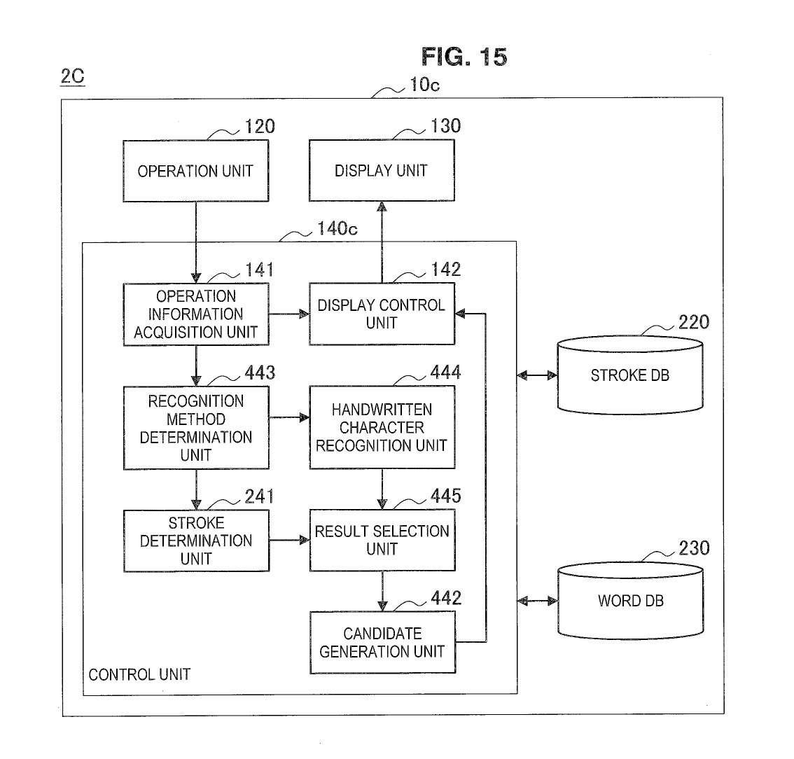

A modified example in which the information processing system according to the second embodiment is constituted by one information processing device will be described with reference to FIG. 15. FIG. 15 is a functional block diagram showing the example of a functional configuration in the modified example in which the information processing system according to the second embodiment is constituted by one information processing device.

Referring to FIG. 15, an information processing system 2c according to the present modified example is provided with a wristwatch-type terminal 10c. Note that the information processing system 2c realizes the same function as the above-described information processing system 2 shown in FIG. 11 with a different configuration of the information processing device.

The wristwatch-type terminal 10c is an example of an information processing device (a so-called wearable terminal) that a user wears and uses. The wristwatch-type terminal 10c can be realized by an information processing device with a hardware configuration to be described in, for example, <4. Hardware configuration> below.

The wristwatch-type terminal 10c is provided with the operation unit 120, the display unit 130, a control unit 140c, the stroke DB 220, and the word DB 230. Here, since each function of the operation unit 120, the display unit 130, the stroke DB 220, and the word DB 230 is the same as the corresponding function of the constituent elements shown in FIG. 11, detailed description thereof will be omitted herein.

The control unit 140c is configured by any of various processors, for example, a CPU, a DSP, and the like to control various processes performed in the wristwatch-type terminal 10c. The control unit 140c has the operation information acquisition unit 141, the display control unit 142, the recognition method determination unit 443, the stroke determination unit 241, the handwritten character recognition unit 444, the result selection unit 445, and the candidate generation unit 442. The function of the control unit 140c including the functions of the units is realized when, for example, the processor configuring the control unit 140c operates according to a predetermined program.

Here, each function of the operation information acquisition unit 141, the display control unit 142, the recognition method determination unit 443, the stroke determination unit 241, the handwritten character recognition unit 444, the result selection unit 445, and the candidate generation unit 442 may be the same as that of the constituent elements shown in FIG. 11. As described above, the wristwatch-type terminal 10c of the present modified example possesses the functions of the wristwatch-type terminal 10 and the portable-type terminal 40 together described with reference to FIG. 11, and thereby the information processing system 2c can be constituted by one information processing device.

The modified example in which the information processing system according to the second embodiment is constituted by one information processing device has been described above with reference to FIG. 15. According to the present modified example, the same effect as that obtained in (1-6-1. Modified example in which the information processing system is constituted by one information processing device) described above can be obtained. In other words, in the present modified example, since the series of processes of the handwriting input process are executed by the wristwatch-type terminal 10c that is the one information processing device, a complicated configuration is not necessary, and the handwriting input process can be executed without considering a communication environment.

(2-4-2. Modified Example in which the Information Processing System is Constituted by Three Information Processing Devices)

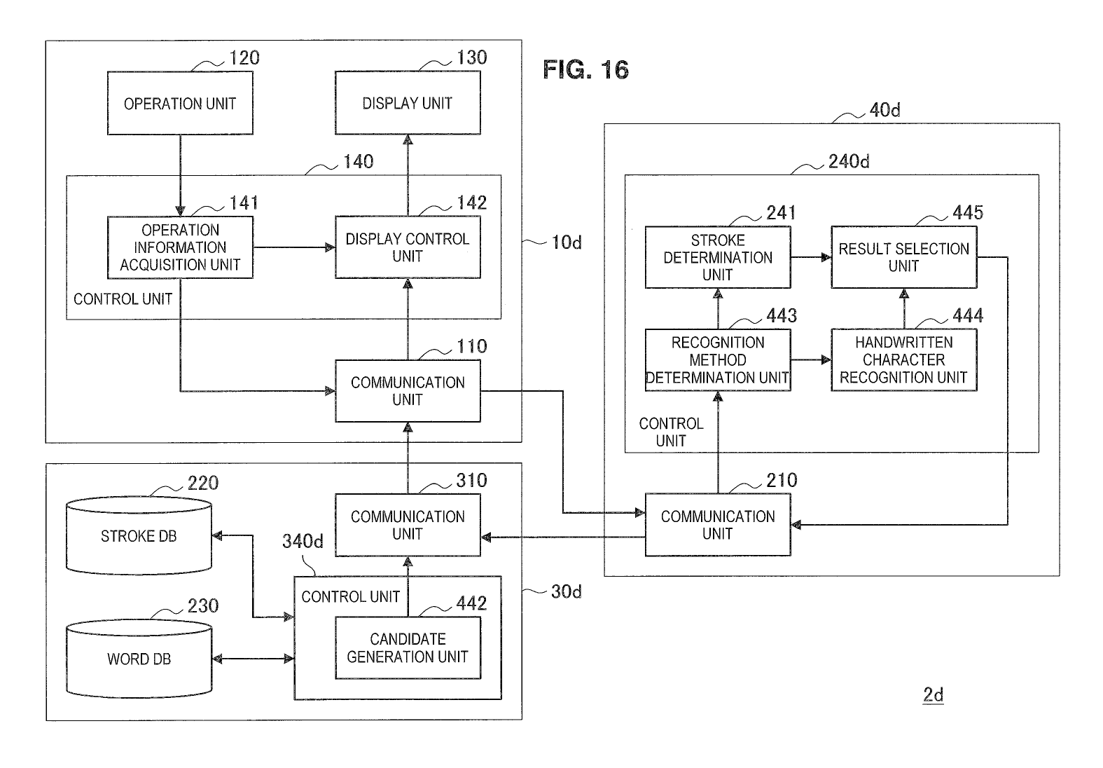

A modified example in which the information processing system according to the second embodiment is constituted by three information processing devices will be described with reference to FIG. 16. FIG. 16 is a functional block diagram showing an example of functional configurations in the modified example in which the information processing system according to the second embodiment is constituted by the three information processing devices.

Referring to FIG. 16, an information processing system 2d according to the present modified example is provided with a wristwatch-type terminal 10d, a portable-type terminal 40d, and a server 30d. Note that the information processing system 2d realizes the same function as the above-described information processing system 2 shown in FIG. 11 with different configurations of the information processing devices.

The wristwatch-type terminal 10d is an example of an information processing device (a so-called wearable terminal) that a user wears and uses. In addition, the portable-type terminal 40d is an example of an information processing device proper for users to carry, for example, a smartphone or a tablet PC. Further, the server 30d is an example of an information processing device that specializes in numerical calculation and information processing, and can be installed on a network (a so-called cloud), for example, the Internet, or the like. The wristwatch-type terminal 10d, the portable-type terminal 40d, and the server 30d can be realized by, for example, information processing devices with the hardware configuration described in <4. Hardware configuration> below. In the present modified example, the handwriting input process is executed when the wristwatch-type terminal 10d, the portable-type terminal 40d, and the server 30d transmit and receive various kinds of information with each other via a network. As a communication scheme used between the wristwatch-type terminal 10d and the portable-type terminal 40d, for example, one based on a communication standard such as Bluetooth, Wi-Fi, or the like can be applied. In addition, as a communication scheme used between the portable-type terminal 40d and the server 30d, for example, any of various communication schemes used in so-called mobile network communication, for example, one based on a communication standard such as GSM; 3G, LTE, Wi-Fi, or the like can be applied.

(Wristwatch-Type Terminal 10d)

The wristwatch-type terminal 10d is provided with the communication unit 110, the operation unit 120, the display unit 130, and the control unit 140. In addition, the control unit 140 has the operation information acquisition unit 141 and the display control unit 142. Since the functional configuration of the wristwatch-type terminal 10d is the same as that of the wristwatch-type terminal 10 shown in FIG. 11, detailed description thereof will be omitted herein.

In the present modified example, however, the communication unit 110 also performs transmission and reception of information with the server 30d in addition to the function that the communication unit 110 of the wristwatch-type terminal 10 shown in FIG. 11 has. In the present modified example, the communication unit 110 transmits operation information including coordinate information of an operating body within a display screen acquired by the operation information acquisition unit 141 to the portable-type terminal 40d. The communication unit 110 can receive candidate information regarding candidates of a letter or a word associated with stroke operations and/or handwritten character input operations generated based on the operation information including the coordinate information from the server 30d. Further, the communication unit 110 may also transmit operation information indicating a word finally selected by a user from displayed candidates acquired by the operation information acquisition unit 141 of the control unit 140 to the server 30d. The communication unit 110 can receive candidate information regarding word candidates that are anticipated to be input after the word in view of the grammar generated based on the aforementioned operation information indicating the finally selected word from the server 30d.

(Portable-Type Terminal 40d)

The portable-type terminal 40d is provided with the communication unit 210 and a control unit 240d.

Here, a function of the communication unit 210 may be substantially the same as that of the communication unit 210 of the portable-type terminal 40 shown in FIG. 11. In the present embodiment, however, in addition to the function of the communication unit 210 of the portable-type terminal 40 shown in FIG. 11, the communication unit 210 also performs transmission and reception of information with the server 30d. In the present modified example, the communication unit 210 receives operation information including coordinate information of an operating body within a display screen from the wristwatch-type terminal 10d. Further, the communication unit 210 can transmit information regarding a determination result of a stroke operation by the stroke determination unit 241 or a recognition result of a handwritten letter by the handwritten character recognition unit 444 selected by the result selection unit 445 of the control unit 240d to be described later to the server 30d.

The control unit 240d is constituted by, for example, any of various processors such as a CPU, a DSP, or the like, and controls various processes performed in the portable-type terminal 40d. The control unit 240d has recognition method determination unit 443, the stroke determination unit 241, the handwritten character recognition unit 444, and the result selection unit 445. A function of the control unit 240d including the functions is realized when, for example, the processor constituting the control unit 240d operates according to a predetermined program.

Here, since each function of the recognition method determination unit 443, the stroke determination unit 241, the handwritten character recognition unit 444, and the result selection unit 445 is the same as that of the constituent elements shown in FIG. 11, detailed description thereof will be omitted herein. In the portable-type terminal 40d, the result selection unit 445 selects whether character recognition should be performed based on a stroke operation or character recognition should be performed based on a handwritten character input operation. Information selected by the result selection unit 445 regarding the determination result of the stroke operation by the stroke determination unit 241 or the recognition result of the handwritten character by the handwritten character recognition unit 444 is transmitted to the server 30d through the communication unit 210. Like this, candidates are not generated in the portable-type terminal 40d in the present modified example. Thus, a load of signal processing in the portable-type terminal 40d is reduced.

(Server 30d)

The server 30d is provided with a communication unit 310, the stroke DB 220, the word DB 230, and a control unit 340d. Here, since each function of the stroke DB 220 and the word DB 230 is the same as that of the constituent elements shown in FIG. 11, detailed description thereof will be omitted.

A function of the communication unit 310 may be substantially the same as that of the communication unit 310 of the server 30b shown in FIG. 10. In the present modified example, however, the communication unit 310 receives the information regarding the determination result of the stroke operation by the stroke determination unit 241 or the recognition result of the handwritten character by the handwritten character recognition unit 444 selected by the result selection unit 445 from the portable-type terminal 40d. The communication unit 310 transmits candidate information regarding candidates of the letter or word associated with the stroke operation and/or handwritten character input operation generated by the candidate generation unit 442 of the control unit 340d to be described later based on the determination result and/or the recognition result to the wristwatch-type terminal 10d. Further, the communication unit 310 may receive operation information acquired by the operation information acquisition unit 141 indicating the word finally selected by the user from displayed candidates from the wristwatch-type terminal 10d. The communication unit 310 can transmit candidate information regarding the candidates of the word that are generated by the candidate generation unit 442 of the control unit 340d to be described later based on the operation information indicating the finally selected word and are anticipated to follow the selected word in view of grammar to the wristwatch-type terminal 10d.

The control unit 340d is constituted by, for example, any of various processors such as a CPU, a DSP, or the like, and controls various processes performed in the server 30d. The control unit 340d has the candidate generation unit 442. A function of the control unit 340d including the function is realized when, for example, the processor constituting the control unit 340d operates according to a predetermined program.

Here, since the function of the candidate generation unit 442 is the same as that of the constituent element shown in FIG. 11, detailed description thereof will be omitted. Based on the determination result of the input stroke operation and/or the recognition result of the character of the handwritten character input operation, the candidate generation unit 442 generates candidates of the letter or the word corresponding to the stroke operation and/or handwritten character input operation. In addition, based on the operation information indicating the word finally selected by the user from the displayed candidate, the candidate generation unit 442 may generate the candidates of the word that are anticipated to follow the selected word in view of grammar. Information regarding the generated candidates of the letter or the word is transmitted to the wristwatch-type terminal 10d through the communication unit 310. In the wristwatch-type terminal 10d, the display control unit 142 causes the candidates of the letter or word to be displayed on the display screen of the handwriting input GUI based on the candidate information.

The modified example in which the information processing system according to the second embodiment is constituted by three information processing devices has been described above with reference to FIG. 16. According to the present modified example, the same effect as that obtained in (1-6-2. Modified example in which the information processing system is constituted by three information processing devices) described above can be obtained. In other words, in the present modified example, since the process performed by the candidate generation unit 442 that is considered to cause the greatest load is performed in the server 30d that is configured to specialize in, for example, signal processing, the handwriting input process can be smoothly performed without causing a burden to the user.

### 3. Modified Examples and Display Examples

Next, several modified examples of the first and second embodiments described above and several display examples with regard to the handwriting input GUI according to the first and second embodiments will be described.

[3-1. Updating of a Stroke DB]

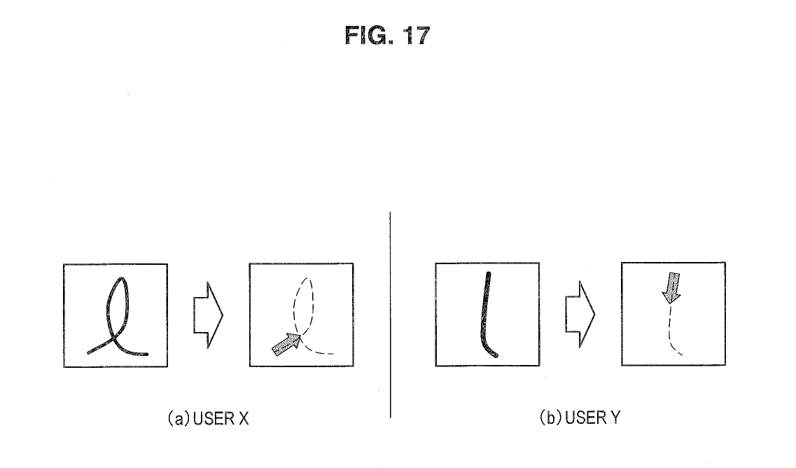

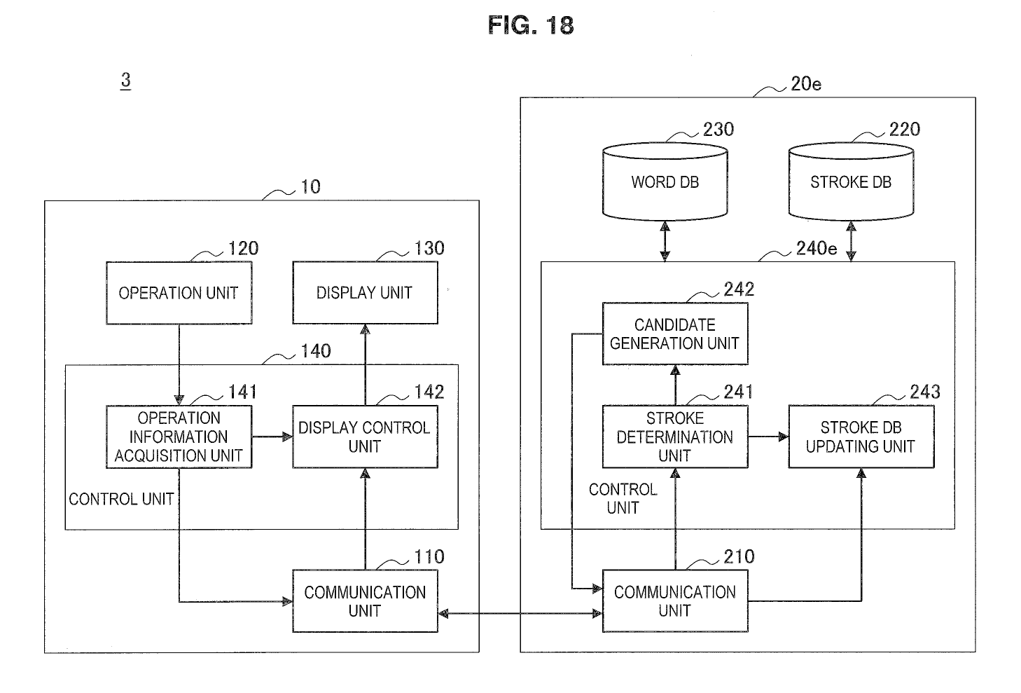

As described above in [1-1. Overview of a handwriting input process], during handwriting of a letter, drawing of strokes of the letter (an order of writing) is considered to differ between users. Thus, in the first and second embodiments, the correspondence relation between stroke operations and letters may be updated so as to deal with writing of letters of users who perform the handwriting input process. Updating the correspondence relation between stroke operations and letters means updating the stroke DB in the information processing systems 1 and 2 exemplified in FIGS. 4 and 11. Herein, a modified example in which the stroke DB 220 is updated will be described with reference to FIGS. 17 and 18.

First, a difference in writing a letter according to users will be described with reference to FIG. 17. FIG. 17 is an illustrative diagram for describing the difference in writing a letter according to the users. In FIG. 17, writing of different users when writing the letter “l” is shown as an example.

Referring to FIG. 17, a user X uses a cursive writing type when writing an “l,” for example, and thus writes the letter as a vertically long ring. Thus, a stroke operation of the user X writing an “l” is a stroke operation in the upper-right direction ((a) of the drawing). On the other hand, a user Y uses a block writing type when writing an “l,” for example, and thus writes the letter as one line in the vertical direction. Thus, a stroke operation of the user Y writing an “l” is a stroke operation in the downward direction ((b) of the drawing).

In the present modified example, based on such a difference in writing a letter according to users, the stroke DB 220 can be updated. Accordingly, a desired letter can be input through a stroke operation that is more intuitive to the user.

Next, an example of a functional configuration of an information processing system for realizing the function of updating the stroke DB 220 will be described with reference to FIG. 18. FIG. 18 is a functional block diagram showing the example of the functional configuration of the information processing system according to the modified example in which the stroke DB 220 is updated. Note that FIG. 18 shows the configuration in which the function of updating the stroke DB 220 is added to the information processing system 1 according to the first embodiment shown in FIG. 4, as the example of the functional configuration of the information processing system according to the present modified example. The function of updating the stroke DB 220 can also be added to the information processing system 2 according to the second embodiment exemplified in FIG. 11.

Referring to FIG. 18, the information processing system 3 according to the present modified example is provided with the wristwatch-type terminal 10 and a portable-type terminal 20e. Here, since the functional configuration of the wristwatch-type terminal 10 is the same as that of the wristwatch-type terminal 10 of the information processing system 1 shown in FIG. 4, detailed description thereof will be omitted herein.

The portable-type terminal 20e is provided with the communication unit 210, the stroke DB 220, the word DB 230, and a control unit 240e. Here, since the functions of the communication unit 210, the stroke DB 220, and the word DB 230 are the same as each function of the constituent elements in the information processing system 1 shown in FIG. 4, detailed description thereof will be omitted herein.

The control unit 240e is constituted by, for example, any of various processors such as a CPU, a DSP, or the like, and controls various processes performed in the portable-type terminal 20e. The control unit 240e has the stroke determination unit 241, the candidate generation unit 442, and a stroke DB updating unit 243. A function of the control unit 240e including the functions is realized when, for example, the processor constituting the control unit 240e operates according to a predetermined program.

Here, since the functions of the stroke determination unit 241 and the candidate generation unit 242 are the same as each function of the constituent elements in the information processing system 1 shown in FIG. 4, detailed description thereof will be omitted herein. In this manner, the information processing system 3 according to the present modified example corresponds to a configuration of the information processing system 1 according to the first embodiment shown in FIG. 4 in which the stroke DB updating unit 243 is added to the control unit 240 of the portable-type terminal 20.

The stroke DB updating unit 243 updates the content of the stroke DB 220 based on input stroke operations and a letter finally selected by a user from displayed candidates. In the present modified example, the stroke DB updating unit 243 can acquire information regarding the input stroke operations from the stroke determination unit 241. In addition, the stroke DB updating unit 243 can acquire information regarding the letter finally selected by the user from the operation information acquisition unit 141 of the wristwatch-type terminal 10 through the communication unit 210. The stroke DB updating unit 243 can acquire the correspondence relation between the input stroke operations and the finally selected letter based on the information. The correspondence relation can be said to indicate, for example, writing of letters according to users, and the correspondence relation between letters and stroke operations according to users. The stroke DB updating unit 243 can update the content of the stroke DB 220 based on the correspondence relation.

The modified example in which the stroke DB 220 is updated as above has been described above with reference to FIGS. 17 and 18. According to the present modified example, based on the correspondence relation between stroke operations performed when the user has input letters in the past and letters, the stroke DB 220 is updated. So to speak, the information processing system 3 has a function of learning such a correspondence relation between stroke operations and letters of each user. With the learning function, the content of the stroke DB 220 is suitable for orders of users' writing of letters, and thus the users can perform stroke operations for inputting letters based on their feelings when normally writing letters, without memorizing stroke operations corresponding to each letter. Therefore, character input through stroke operations can be learned within a shorter period of time, and accordingly, time taken for letter input can be further reduced.

[3-2. Display of a Trace of an Operating Body]

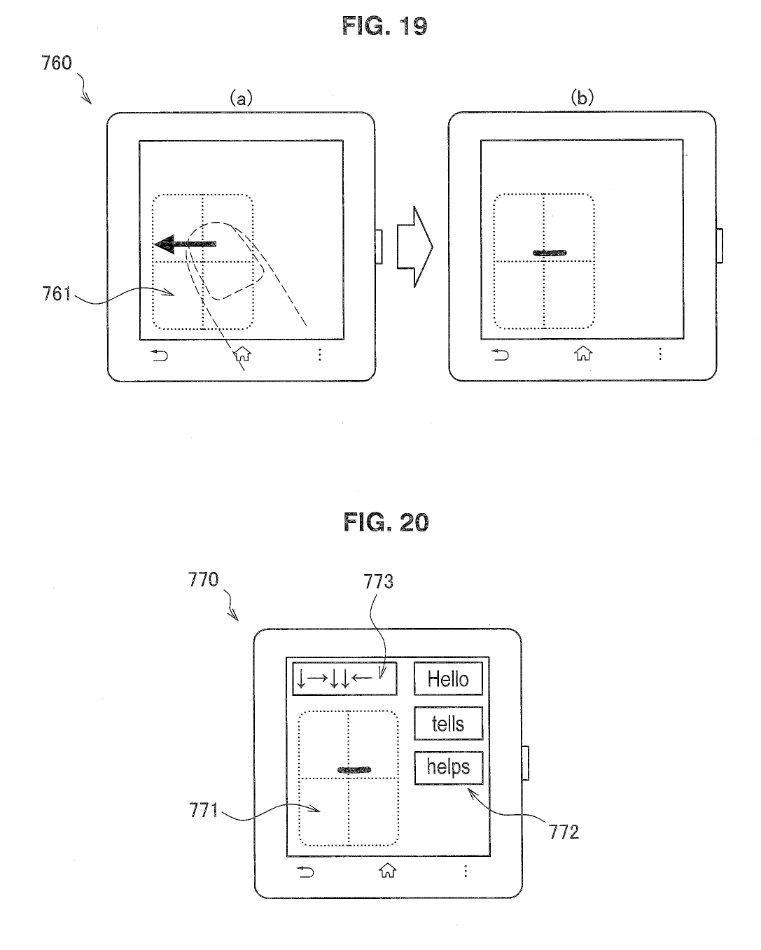

As described with reference to FIG. 2, a trace of the operating body input by a user on the display screen of the handwriting input GUI may be displayed on the display screen in the first and second embodiments. Herein, a display example in which a trace of an operating body is displayed on a display screen of a handwriting input GUI will be described again with reference to FIG. 19. FIG. 19 is a diagram showing the display example of the handwriting input GUI when a trace of the operating body is displayed on the display screen.

Referring to FIG. 19, the display screen 760 of the handwriting input GUI has an input region 761. The input region 761 is a region, for example, corresponding to the input region 711 shown in FIGS. 2 and 3, in which a user inputs stroke operations and/or handwritten character input operations. In the example shown in FIG. 19, the user inputs a stroke operation in the left direction in the input region 761 ((a) of the drawing). In addition, in response to the operation, a trace of the operating body of the stroke operation is displayed in the input region 761 ((b) of the drawing).

Note that FIG. 19 illustrates the display example in which the trace of the operating body is displayed when the user inputs the stroke operation, however, even when the user inputs a handwritten character input operation, a trace of the operating body may likewise be displayed in the input region 761. In this manner, with the trace of the operating body displayed on the display screen 760, the user can intuitively grasp the stroke operation and/or handwritten character input operation that he or she has input.

[3-3. Display of a History of Input Stroke Operations]

As described with reference to FIG. 8, when a plurality of stroke operations are consecutively input in the handwriting input GUI according to the first and second embodiments, a history of the input stroke operations may be displayed on the display screen of the handwriting input GUI. Herein, a modified example in which a history of input stroke operations is displayed on a display screen of a handwriting input GUI will be described with reference to FIG. 20. FIG. 20 is a diagram showing one display example of a handwriting input GUI when a history of input stroke operations is displayed on a display screen.

Referring to FIG. 20, the display screen 770 of the handwriting input GUI has an input region 771, a candidate display region 772, and a stroke history display region 773. The input region 771 is a region corresponding to, for example, the input region 711 shown in FIGS. 2 and 3, in which a user inputs stroke operations and/or handwritten character input operations. The candidate display region 772 is a region corresponding to, for example, the candidate display region 712 shown in FIGS. 2 and 3, in which candidates of input stroke operations and/or handwritten character input operations are displayed.

The stroke history display region 773 is a region in which a history of stroke operations input by the user is displayed. In the example shown in FIG. 20, a plurality of arrows are displayed in one row in the stroke history display region 773. Each of the arrows corresponds to a direction of a stroke operation. Although not illustrated in FIG. 20, for example, for a stroke operation indicating a dot, any other symbol such as a dot may be displayed, instead of an arrow. With reference to the stroke history display region 773, the user can intuitively grasp the history of stroke operations he or she has input.

Note that, on the display screen of the handwriting input GUI according to the first and second embodiments, various functions may not be designated to explicit GUI components such as icons, and a pre-set given function may be executed by, for example, performing a predetermined operation in a predetermined region. For example, on the display screen 770 shown in FIG. 20, icons like the backspace icon 714 and menu icon 715 on the display screen 710 shown in FIG. 2 are not displayed. However, an operation of dragging a finger in a certain direction in the candidate display region 772, for example, may be designated as a backspace operation. For example, when the user performs an operation of dragging his or her finger in the left direction in the candidate display region 772, a previously input stroke operation may be cancelled. In a quite small-sized information processing device such as a wristwatch-type terminal, for example, it is difficult to display a number of icons on the screen as GUI components. As described above, by designating a predetermined function for a predetermined operation in the handwriting input GUI, many functions can be included in the handwriting input GUI even when the handwriting input GUI is displayed within quite a small screen, and thus user convenience is further enhanced.

[3-4. Input of a Number and a Symbol]

The first and second embodiments have been described in <1. First embodiment> and <2. Second embodiment> described above, exemplifying the case in which a letter is input in the handwriting input process. The first and second embodiments, however, are not limited thereto. In the handwriting input process according to the first and second embodiments, elements other than letters (figures having predetermined sounds or meanings formed of sets of predetermined dots and lines) may be input. For example, in the first and second embodiments, numbers and symbols other than letters may be associated with stroke operations, and numbers and symbols may be input through stroke operations.

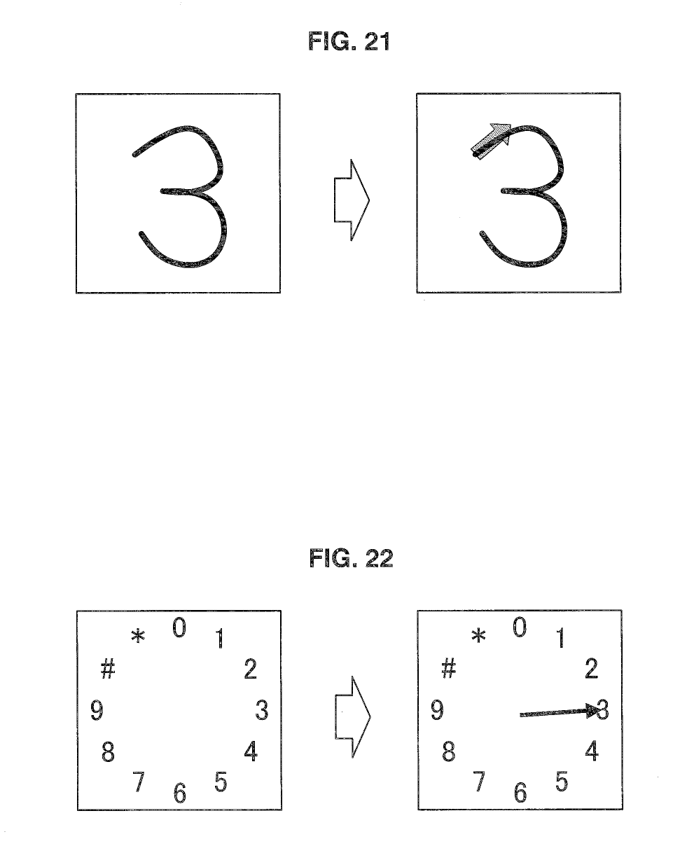

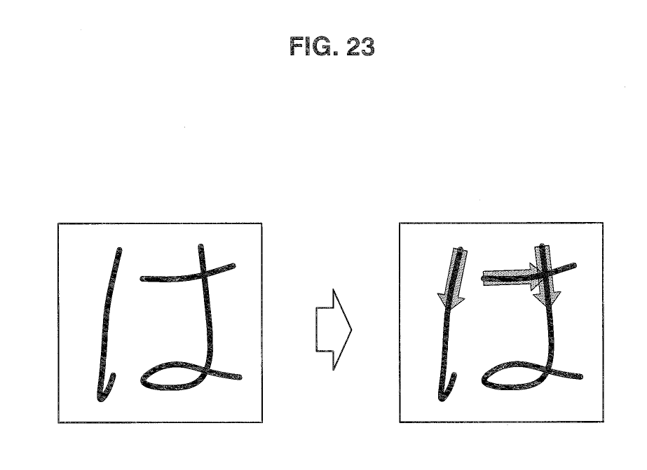

A modified example in which a number and a symbol are input through stroke operations will be described with reference to FIGS. 21 and 22. FIG. 21 is an illustrative diagram for describing a correspondence relation between a stroke operation and a number.

Referring to FIG. 21, the Arabic numeral “3” is illustrated as an example of a number. As indicated by the arrow in the drawing, a moving direction of an operating body when drawing a “3” can be an upper-right direction. In the present modified example, for example, the Arabic numeral “3” may be associated with a stroke operation corresponding to drawing for handwriting a “3” in the same manner as letters. When a user wants to input a “3” and performs a stroke operation in the upper-right direction, for example, a “3” can be displayed in the handwriting input GUI as a candidate of the number corresponding to the stroke operation. Note that, in FIG. 21, the number is illustrated as an example; however, for symbols, a predetermined symbol may be associated with a stroke operation corresponding to drawing for handwriting the symbol in the same manner.

FIG. 22 is an illustrative diagram for describing another correspondence relation between a stroke operation and a number. Referring to FIG. 22, the Arabic numerals 0 to 9 and the symbols “#” and “*” are illustrated arranged in a circular shape like a dial plate of a watch. In the present modified example, the numbers and symbols arranged in the circular shape may be associated with stroke operations performed in the directions from the center of the circle to the numbers and symbols. In this manner, regardless of drawing for handwriting the numbers and symbols, stroke operations in predetermined directions may be designated for predetermined numbers and symbols. When a user wants to input a “3” and thus performs a stroke operation in the direction from the center of the circle to the “3” shown in FIG. 22, i.e., in the right direction, a “3” can be displayed in the handwriting input GUI as a candidate of the number corresponding to the stroke operation. In the example shown in FIG. 22, since the numbers are arranged in the circular shape so as to correspond to a dial plate of a watch, when the user pictures arrangement of numbers on a dial plate of a watch in his or her mind, he or she can be easily reminded of the correspondence relation between stroke operations and the numbers. Note that, although FIG. 22 illustrates the case in which one number and symbol are associated with one direction as an example, a plurality of numbers and symbols may be associated with one direction.

The modified examples in which numbers and symbols are input through stroke operations have been described with reference to FIGS. 21 and 22. Such correspondence relations between stroke operations and numbers and symbols may be stored in, for example the stroke DB 220 shown in FIGS. 4 and 11 in the present modified examples. Based on directions of input stroke operations, the candidate generation units 242 and 442 can generate numbers and symbols corresponding to the stroke operations with reference to the stroke DB 220.

[3-5. Input of a Character of Another Language]

The first and second embodiments have been described above in <1. First embodiment> and <2. Second embodiment>, exemplifying the case in which Latin letters are input. The first and second embodiments, however, are not limited thereto. In a handwriting input process according to the first and second embodiments, characters of a language other than English may be associated with stroke operations, and characters of another language may be input through stroke operations.

A modified example in which a character of another language is input through stroke operations will be described with reference to FIG. 23. FIG. 23 is an illustrative diagram for describing a correspondence relation between a stroke operation and a character of another language.

Referring to FIG. 23, “ha” of hiragana of the Japanese language is illustrated as an example of a character of another language. In the present modified example, for example, “ha” of hiragana of the Japanese language may be associated with a stroke operation corresponding to drawing for handwriting “ha” in the same manner as letters. For example, as indicated by the arrow in the drawing, a stroke operation corresponding to a first stroke when writing “ha” can be a stroke operation in the downward direction. Thus, when a user wants to input “ha” and thus performs the stroke operation in the downward direction, “ha” can be displayed in the handwriting input GUI as a candidate of the character corresponding to the stroke operation.

Here, the number of strokes of hiragana “ha” is three. Thus, in the present modified example, the one character “ha” is not associated with one stroke, and the one character “ha” may be associated with stroke operations for three strokes. As indicated by the arrows in the drawing, the direction in which the first stroke of “ha” is drawn is the downward direction, the direction in which the second stroke thereof is drawn is the upper-right direction, and the direction in which the third stroke thereof is drawn is the downward direction. Thus, “ha” may be associated with a combination of the stroke operation in the downward direction, the stroke operation in the right direction, and the stroke operation in the downward direction. When a user wants to input “ha” and thus consecutively performs the stroke operation in the downward direction, the stroke operation in the right direction, and the stroke operation in the downward direction, for example, “ha” can be displayed in the handwriting input GUI as a candidate of the character corresponding to the combination of the stroke operations. In this manner, a combination of a plurality of stroke operations may be associated with one character in a language system in which the number of strokes of one character is relatively large. By making such association, accuracy in character recognition based on stroke operations can be improved.

### 4. Hardware Configuration

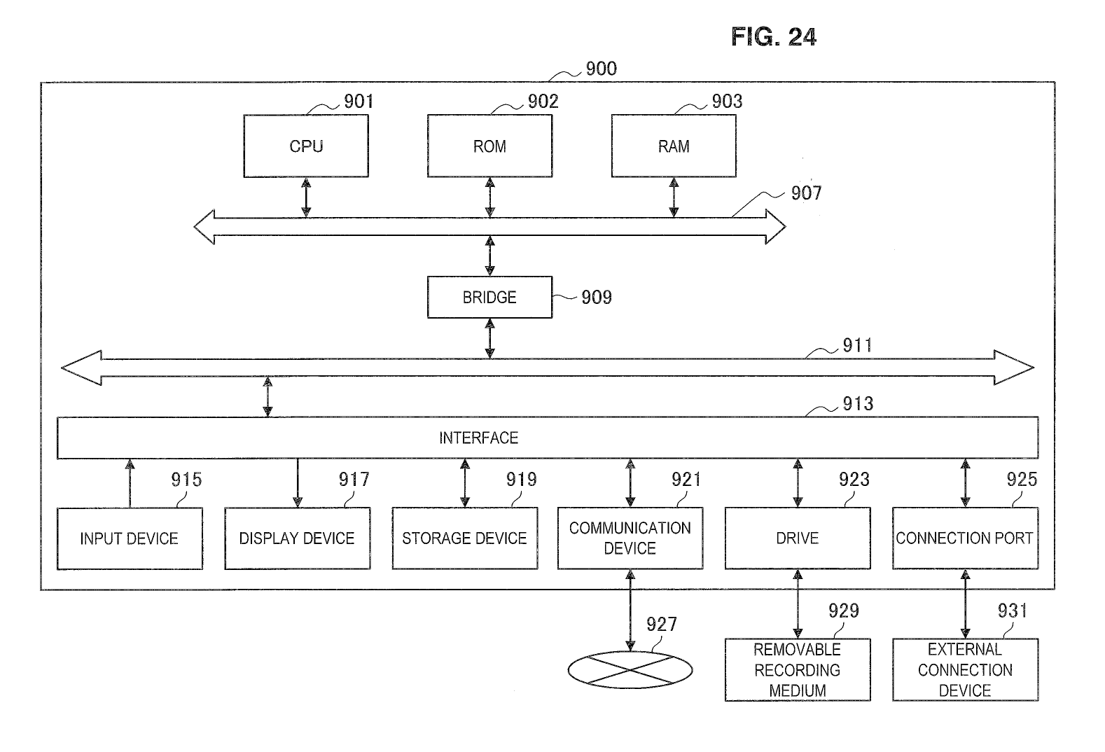

Next, a hardware configuration of the information processing device according to the first and second embodiments will be described with reference to FIG. 24. FIG. 24 is a functional block diagram showing an example of the hardware configuration of the information processing device according to the first and second embodiments. Note that the information processing device 900 shown in FIG. 24 can realize the wristwatch-type terminals, the portable-type terminals, and the servers shown in, for example, FIGS. 4, 9, 10, 11, 15, 16, and 18.

The information processing device 900 includes a CPU 901, a read only memory (ROM) 902, and a random access memory (RAM) 903. The information processing device 900 may further include a host bus 907, a bridge 909, an external bus 911, an interface 913, an input device 915, an output device 917, a storage device 919, a communication device 921, a drive 923, and a connection port 925. The information processing device 900 may include, instead of or along with the CPU 901, a processing circuit such as a digital signal processor (DSP) or an application specific integrated circuit (ASIC).

The CPU 901 functions as an arithmetic processing unit and a control unit and controls an entire operation or a part of the operation of the information processing device 900 according to various programs recorded in the ROM 902, the RAM 903, the storage device 919, or a removable recording medium 929. The ROM 902 stores programs and arithmetic parameters used by the CPU 901. The RAM 903 temporarily stores programs used in execution of the CPU 901 and parameters and the like used during the execution. The CPU 901, the ROM 902, and the RAM 903 are connected to each other via the host bus 907 configured from an internal bus such as a CPU bus or the like. In addition, the host bus 907 is connected to the external bus 911 such as a peripheral component interconnect/interface (PCI) bus via the bridge 909. The CPU 901 corresponds to, for example, the control units of the wristwatch-type terminals, the portable-type terminals, and the servers of the first and second embodiments. The host bus 907 is connected to the external bus 911 such as a peripheral component interconnect/interface (PCI) bus via the bridge 909.

The input device 915 is configured by a device operated by a user, for example, a mouse, a keyboard, a touch panel, buttons, a switch, and a lever. Also, the input device 915 may be a remote control device (a so-called remote controller) using, for example, infrared light or other radio waves, or may be an external connection device 931 such as a mobile phone or a PDA compatible with the operation of the information processing device 900. The input device 915 includes an input control circuit that generates an input signal on the basis of information inputted by the user by use of the above described operation means and outputs the input signal to the CPU 901, for example. The user of the information processing device 900 can input various kinds of data to the information processing device 900 and can instruct the information processing device 900 to perform a processing operation by operating the input device 915. The input device 915 corresponds to, for example, the operation unit 120 of the wristwatch-type terminal described above, in the present embodiment. In the first and second embodiments, for example, the user can perform various kinds of operation input of, for example, stroke operations and handwritten character input operations in the handwriting input GUI with the input device 915.

The output device 917 is configured by a device capable of visually or aurally notifying the user of acquired information. The output device may be a display device such as a CRT display, a liquid crystal display, a plasma display device, an EL display device, or a lamp; an audio output device such as a speaker and headphones; or a printer. The output device 917 outputs results obtained by various kinds of processing performed by the information processing device 900, for example. Specifically, the display device displays visually the results obtained from the various kinds of processing performed by the information processing device 900 in any of various forms such as text, an image, a table, and a graph. The display device corresponds to, for example, the display units 130 of the wristwatch-type terminals described above in the first and second embodiments. The handwriting input GUI may be displayed in the display device in the first and second embodiments. On the other hand, the audio output device outputs aurally an audio signal such as reproduced sound data or acoustic data being converted into an analog signal.

The storage device 919 is a device for storing data configured as an example of a storage unit of the information processing device 900. The storage device 919 is configured by, for example, a magnetic storage device such as an HDD, a semiconductor storage device, an optical storage device, or a magneto-optical storage device. This storage device 919 stores programs to be executed by the CPU 901, various data, and various data obtained from the outside. The storage device 919 configures, for example, the stroke DBs 220 and the word DBs 230 of the portable-type terminals and the servers described above in the first and second embodiments.

The communication device 921 is a communication interface configured by, for example, a communication device for establishing a connection to a communication network (network) 927. The communication device 921 is a communication card for, for example, a wired or wireless local area network (LAN), Bluetooth, wireless USB (WUSB), or the like. Alternatively, the communication device 921 may be a router for optical communication, a router for asymmetric digital subscriber line (ADSL), a modem for various communications, or the like. The communication device 921 can transmit and receive signals and the like using a given protocol such as TCP/IP on the Internet and with other communication devices, for example. Further, the network 927 connected to the communication device 921 is configured by a network and the like, which is connected via wire or wirelessly, and may be, for example, the Internet, a home-use LAN, infrared communication, radio wave communication, satellite communication, or the like. The communication device 921 corresponds to, for example, the communication units 110, 210, and 310 of the wristwatch-type terminals, the portable-type terminals, and the servers described above, in the present embodiment. In the first and second embodiment, information such as various kinds of operation information (for example, coordinate information of the operating body within the display control and the like) with respect to the handwriting input GUI, candidate information regarding candidates displayed in the handwriting input GUI, and the like may be transmitted and received with other devices by the communication device 921 through the network 927.

The drive 923 is a reader/writer for a recording medium and is built in or externally attached to the information processing device 900. The drive 923 reads out information recorded on the loaded removable recording medium 929, such as a magnetic disk, an optical disc, a magneto-optical disc, or a semiconductor memory, and outputs the information to the RAM 903. Further, the drive 923 can write information on the loaded removable recording medium 929, such as a magnetic disk, an optical disc, a magneto-optical disc, or a semiconductor memory. Examples of the removable recording medium 929 include a DVD medium, an HD-DVD medium, a Blu-ray (registered trademark) medium. Alternatively, the removable recording medium 929 may be a Compact Flash (CF; a registered trademark), a flash memory, a secure digital memory card (SD memory card), or the like. Further alternatively, the removable recording medium 929 may be, for example, an integrated circuit card (IC card) on which a contactless IC chip is mounted, an electronic device, or the like. In the first and second embodiments, various kinds of information of a handwriting input process may be read out from the removable recording medium 929, or written on the removable recording medium 929 in the drive 923.

The connection port 925 is a port for allowing devices to directly connect to the information processing device 900. Examples of the connection port 925 include a universal serial bus (USB) port, an IEEE1394 port, and a small computer system interface (SCSI) port. Other examples of the connection port 925 may include an RS-232C port, an optical audio terminal, and a high-definition multimedia interface (HDMI; a registered trademark) port. The connection of the external connection device 931 to the connection port 925 may enable the information processing device 900 to directly acquire the various data from the external connection device 931 or to provide the data to the external connection device 931. In the first and second embodiments, various kinds of information of a handwriting input process may be acquired from the external connection device 931 or output to the external connection device 931 through the connection port 925.

The example of the hardware configuration that can realize the functions of the information processing device 900 according to the first and the second embodiments of the present disclosure has been described above. Each constituent element described above may be formed by a common member or configured by hardware that specializes in the functions of each constituent element. Accordingly, it is possible to change the hardware configuration to be used as appropriate depending on technique levels each time the embodiments are executed.

Note that it is possible to create a computer program for realizing each function of the above described information processing device 900 of the above-described first and second embodiments and to incorporate the program in a PC or the like. Further, it is possible to provide a computer-readable recording medium having such a computer program stored therein. The recording medium may be, for example, a magnetic disk, an optical disc, a magneto-optical disc, or a flash memory. Further, the computer program may be distributed through a network, for example, without using the recoding medium. In addition, the computer program may be operated in a server (web server) and/or a web browser provided on a network such as the Internet, and various functions relating to a handwriting input process may be provided to users in the form of a so-called web application. In such a case, the users can execute the handwriting input process according to the first and second embodiments on the web browser.

### 5. Supplementary Explanation

Although the preferred embodiments of the present disclosure have been described above in detail with reference to the appended drawings, the technical scope of the present disclosure is not limited thereto. It should be understood by those skilled in the art that various modifications, combinations, sub-combinations and alterations may occur depending on design requirements and other factors insofar as they are within the scope of the appended claims or the equivalents thereof.

The effects described in the specification are just explanatory or exemplary effects, and are not limiting. That is, the technology according to the present disclosure can exhibit other effects that are apparent to a person skilled in the art from the descriptions in the specification, along with the above effects or instead of the above effects.

Note that, in the above-described embodiments, for example, the display screens 710, 720, 730, 740, 750, 760, and 770 are shown as examples of the handwriting input GUIs in FIGS. 2, 3, 6, 7, 8, 14, 19, and 20. The present technology, however, is not limited thereto. The display screens of the handwriting input GUIs may be configured so as to realize the function of the handwriting input processes of the first and second embodiments, and specific configurations of the display screens of the handwriting input GUIs may be appropriately set. For example, the various regions and GUI components such as icons displayed in the above-described display screens 710, 720, 730, 740, 750, 760, and 770 may be used by being combined with each other where possible.

Further, when the information processing system according to the first and second embodiments is constituted by a plurality of information processing devices, an information processing device in which a user performs letter and word input operations may be seamlessly shifted to another if necessary. For example, the information processing system 1 shown in FIG. 4 is constituted by the wristwatch-type terminal 10 and the portable-type terminal 20. In addition, stroke operations for inputting letters and words are performed in the wristwatch-type terminal 10. Here, when a statement that includes a number of words is desired to be input, for example, there is a possibility of difficulty in continuing inputting letters and words in the wristwatch-type terminal 10 that has a relatively small screen. In such a case, in linkage between the wristwatch-type terminal 10 and the portable-type terminal 20, a device in which letter and word input operations are performed may be shifted from the wristwatch-type terminal 10 to the portable-type terminal 20 during input of the statement.

For example, as a user performs a predetermined operation for shifting a device in which letter and word input operations are performed with respect to the wristwatch-type terminal 10 to the portable-type terminal 20, a display screen of the handwriting input GUI is displayed on the display unit of the portable-type terminal 20 in the state in which the letters and words which have already been input in the wristwatch-type terminal 10 are reflected. The user then can perform letter and word input operations from a middle of the statement in the handwriting input GUI displayed in the portable-type terminal 20. Since the portable-type terminal 20 has a larger display screen than the wristwatch-type terminal 10, a wider area can be secured as, for example, the word display region 713 shown in FIGS. 2 and 3, and even a long input statement can be displayed so as to fit in the word display region 713. In this manner, the portable-type terminal 20 that can have a larger screen can realize display of the handwriting input GUI more proper for inputting a long statement. Thus, by appropriately shifting a device in which letter and word input operations are performed seamlessly according to, for example, a length of a statement to be input, a handwriting input process can be performed with greater convenience.

Furthermore, the handwriting input process according to the first and second embodiments may be combined with, for example, another letter input process such as letter input using a keyboard. When a device in which letter and word input operations are performed is shifted from the wristwatch-type terminal 10 to the portable-type terminal 20 as described above, for example, letter and word input performed in the portable-type terminal 20 after the shift may be performed in a general letter input process using, for example, a keyboard or the like. Since the portable-type terminal 20 can have a larger display screen than the wristwatch-type terminal 10, there is a low possibility of difficulty in selecting a key when, for example, a qwerty keyboard is displayed on the display screen. In this manner, while a device in which letter and word input operations are performed is appropriately shifted, letter input processes proper for each device may be selected. Thereby, a letter input process can be performed with greater convenience.

Further, although stroke operations are input through motions of the operating bodies on the display screens of the handwriting input GUIs in the above-described embodiments, the first and second embodiments are not limited thereto. In the first and second embodiments, an input interface can be used as long as it is a device into which information indicating directions is input, and the input interface for inputting stroke operations into an information processing device can adopt various forms. For example, the information processing device may be provided with a sensor unit that is configured by an imaging device, a distance measuring sensor, or the like and can recognize motions of a user as an input interface.

Such a sensor unit can detect motions of a user (for example, motions of a part of the body, and motions of the eyeballs of the user (i.e., movements of the line of sight)) by performing analysis with, for example, motion vectors. In addition, by detecting a predetermined gesture or a movement of the line of sight from motions of the user, stroke operations may be input according to the gesture or movement of the line of sight. For example, a gesture of the user made when the user moves his or her arm in one direction or a movement of the line of sight in one direction may be detected as a stroke operation. Further, the information processing device may have a configuration of an acceleration sensor, a gyro sensor, or the like, and be provided with a remote controller that can detect attitudes and motions of the device itself as an input interface. As a motion of a hand of a user who holds the remote controller is detected by the remote controller, a stroke operation may be input according to the motion of the remote controller. For example, a movement of the user shaking the remote controller in his or her hand in a predetermined direction may be detected as a stroke operation in that direction. Further, for example, the information processing device may also be provided with a device with which information indicating directions can be input more directly, such as a joystick or a controller with direction keys, as an input interface. In such a case, a direction input by the joystick or the controller with direction keys can be input as a direction of a stroke operation. In this manner, in the first and second embodiments, stroke operations can be input through various types of input interfaces as long as they are input interfaces configured to be capable of inputting information indicating directions.

Additionally, the present technology may also be configured as below.

(1) An information processing device including:
an operation information acquisition unit configured to acquire operation information that is information regarding operation input by a user; and
a display control unit configured to cause at least a candidate of a letter corresponding to a stroke operation, which is an operation determined based on the operation information and indicates a predetermined direction, to be displayed on a screen according to the stroke operation.
(2) The information processing device according to (1), wherein, based on a combination of a plurality of the stroke operations that are consecutively input, the display control unit causes candidates of a word corresponding to the combination to be displayed on the screen.
(3) The information processing device according to (1) or (2), wherein the display control unit causes a history of a plurality of the input stroke operations to be displayed on the screen.
(4) The information processing device according to any one of (1) to (3), wherein, after a plurality of the stroke operations are consecutively input, the display control unit causes a character designation region that is a region in which candidates of letters corresponding to each of the consecutively input stroke operations are displayed to designate the letters for each of the consecutively input stroke operations to be displayed on the screen.
(5) The information processing device according to any one of (1) to (4), wherein the display control unit causes a plurality of candidates corresponding to a plurality of the input stroke operations to be displayed in an order of a predetermined priority.
(6) The information processing device according to (5), wherein, when any one of the plurality of displayed candidates is selected, the display control unit causes the plurality of candidates to be displayed in an order of a different priority based on the selected candidate.
(7) The information processing device according to any one of (1) to (6),
wherein the operation information acquisition unit acquires at least coordinate information of an operating body within the screen as the operation information, and
wherein the stroke operation is an operation which is determined based on the coordinate information and in which the operating body moves in a predetermined direction on the screen.
(8) The information processing device according to (7), wherein the display control unit causes a trace of the operating body in the stroke operation to be displayed on the screen.
(9) The information processing device according to (7) or (8), wherein the display control unit switches display of the screen between a first display state in which an input region in which the stroke operation is input by the operating body and candidates corresponding to the stroke operation are displayed together and a second display state in which the input region is not displayed and the candidates are displayed in a form of a list.
(10) The information processing device according to any one of (7) to (9), wherein the display control unit causes at least a candidate of a letter corresponding to a handwritten character input operation that is an operation of drawing at least an entire shape of the letter with the operating body, and is recognized based on the coordinate information of the operating body, to be displayed on the screen.
(11) The information processing device according to (10), wherein, based on a combination of at least one of the consecutively input stroke operations and at least one of handwritten character input operations, the display control unit causes a candidate of a word corresponding to the combination to be displayed on the screen.
(12) The information processing device according to (10) or (11), further including: a recognition method determination unit configured to determine whether an input operation performed by the operating body is the stroke operation or the handwritten character input operation based on the coordinate information of the operating body acquired by the operation information acquisition unit,
wherein, according to a determination result obtained by the recognition method determination unit, the display control unit causes a candidate corresponding to the stroke operation or the handwritten character input operation to be displayed on the screen.
(13) The information processing device according to any one of (10) to (12), further including:
a result selection unit configured to determine accuracy of a recognition result when at least a letter is recognized based on the handwritten character input operation,
wherein, according to a determination result obtained by the result selection unit, the display control unit causes a candidate corresponding to the stroke operation or the handwritten character input operation to be displayed on the screen.
(14) The information processing device according to any one of (10) to (13), wherein, after the stroke operations are consecutively input, the display control unit causes a display screen relating to a re-input mode that is a mode in which letters corresponding to each of the consecutively input stroke operations are input again through the handwritten character input operation to be displayed on the screen.
(15) The information processing device according to any one of (1) to (14), wherein, in a correspondence relation between the stroke operation and at least a letter, a predetermined letter is associated with the stroke operation corresponding to drawing for handwriting the letter.
(16) The information processing device according to any one of (1) to (15), wherein, based on the stroke operation input by a predetermined user and a candidate that is finally selected from candidates displayed corresponding to the stroke operation, the correspondence relation between the stroke operation and at least the letter is updated according to the user.
(17) The information processing device according to any one of (1) to (16), wherein the display control unit causes a candidate of a number or a symbol corresponding to the input stroke operation to be displayed on the screen.
(18) The information processing device according to (2), wherein, when any one of the displayed candidates of the word is selected, the display control unit causes word candidates that are anticipated to follow the selected word in view of grammar to be displayed on the screen.
(19) An information processing method including:
acquiring operation information that is information regarding operation input by a user; and
causing at least a candidate of a letter corresponding to a stroke operation, which is an operation determined based on the operation information and indicates a predetermined direction, to be displayed on a screen according to the stroke operation.
(20) A program causing a processor of a computer to realize functions of:
acquiring operation information that is information regarding operation input by a user; and
causing at least a candidate of a letter corresponding to a stroke operation, which is an operation determined based on the operation information and indicates a predetermined direction, to be displayed on a screen according to the stroke operation.

What is claimed is:

1. An information processing device comprising:
an operation information acquisition unit configured to acquire operation information that is information regarding operation input by a user; and
a display control unit configured to cause at least a candidate of a letter corresponding to a stroke operation, which is an operation determined based on the operation information and indicates a predetermined direction, to be displayed on a screen according to the stroke operation.

2. The information processing device according to claim 1, wherein, based on a combination of a plurality of the stroke operations that are consecutively input, the display control unit causes candidates of a word corresponding to the combination to be displayed on the screen.

3. The information processing device according to claim 1, wherein the display control unit causes a history of a plurality of the input stroke operations to be displayed on the screen.

4. The information processing device according to claim 1, wherein, after a plurality of the stroke operations are consecutively input, the display control unit causes a character designation region that is a region in which candidates of letters corresponding to each of the consecutively input stroke operations are displayed to designate the letters for each of the consecutively input stroke operations to be displayed on the screen.

5. The information processing device according to claim 1, wherein the display control unit causes a plurality of candidates corresponding to a plurality of the input stroke operations to be displayed in an order of a predetermined priority.

6. The information processing device according to claim 5, wherein, when any one of the plurality of displayed candidates is selected, the display control unit causes the plurality of candidates to be displayed in an order of a different priority based on the selected candidate.

7. The information processing device according to claim 1,
wherein the operation information acquisition unit acquires at least coordinate information of an operating body within the screen as the operation information, and
wherein the stroke operation is an operation which is determined based on the coordinate information and in which the operating body moves in a predetermined direction on the screen.

8. The information processing device according to claim 7, wherein the display control unit causes a trace of the operating body in the stroke operation to be displayed on the screen.

9. The information processing device according to claim 7, wherein the display control unit switches display of the screen between a first display state in which an input region in which the stroke operation is input by the operating body and candidates corresponding to the stroke operation are displayed together and a second display state in which the input region is not displayed and the candidates are displayed in a form of a list.

10. The information processing device according to claim 7, wherein the display control unit causes at least a candidate of a letter corresponding to a handwritten character input operation that is an operation of drawing at least an entire shape of the letter with the operating body, and is recognized based on the coordinate information of the operating body, to be displayed on the screen.

11. The information processing device according to claim 10, wherein, based on a combination of at least one of the consecutively input stroke operations and at least one of handwritten character input operations, the display control unit causes a candidate of a word corresponding to the combination to be displayed on the screen.

12. The information processing device according to claim 10, further comprising:
a recognition method determination unit configured to determine whether an input operation performed by the operating body is the stroke operation or the handwritten character input operation based on the coordinate information of the operating body acquired by the operation information acquisition unit,
wherein, according to a determination result obtained by the recognition method determination unit, the display control unit causes a candidate corresponding to the stroke operation or the handwritten character input operation to be displayed on the screen.

13. The information processing device according to claim 10, further comprising:
a result selection unit configured to determine accuracy of a recognition result when at least a letter is recognized based on the handwritten character input operation,
wherein, according to a determination result obtained by the result selection unit, the display control unit causes a candidate corresponding to the stroke operation or the handwritten character input operation to be displayed on the screen.

14. The information processing device according to claim 10, wherein, after the stroke operations are consecutively input, the display control unit causes a display screen relating to a re-input mode that is a mode in which letters corresponding to each of the consecutively input stroke operations are input again through the handwritten character input operation to be displayed on the screen.

15. The information processing device according to claim 1, wherein, in a correspondence relation between the stroke operation and at least a letter, a predetermined letter is associated with the stroke operation corresponding to drawing for handwriting the letter.

16. The information processing device according to claim 15, wherein, based on the stroke operation input by a predetermined user and a candidate that is finally selected from candidates displayed corresponding to the stroke operation, the correspondence relation between the stroke operation and at least the letter is updated according to the user.

17. The information processing device according to claim 1, wherein the display control unit causes a candidate of a number or a symbol corresponding to the input stroke operation to be displayed on the screen.

18. The information processing device according to claim 2, wherein, when any one of the displayed candidates of the word is selected, the display control unit causes word candidates that are anticipated to follow the selected word in view of grammar to be displayed on the screen.

19. An information processing method comprising:
acquiring operation information that is information regarding operation input by a user; and
causing at least a candidate of a letter corresponding to a stroke operation, which is an operation determined based on the operation information and indicates a predetermined direction, to be displayed on a screen according to the stroke operation.

20. A program causing a processor of a computer to realize functions of:
acquiring operation information that is information regarding operation input by a user; and
causing at least a candidate of a letter corresponding to a stroke operation, which is an operation determined based on the operation information and indicates a predetermined direction, to be displayed on a screen according to the stroke operation.
